(19) United States
(12) Patent Application Publication
(10) Pub. No.: US 2026/0039442 A1
(43) Pub. Date: Feb. 5, 2026

(54) CHANNEL STATE INFORMATION (CSI) COMPUTING BASED ON MULTIPLE CSI CONFIGURATIONS

(71) Applicant: Apple, Inc., Cupertino, CA (US)

(72) Inventors: Sairamesh Nammi, Cupertino, CA (US); Divyaprakash P. Bhojkumar, San Jose, CA (US); Ismael Gutierrez Gonzalez, San Jose, CA (US); Sreevalsan Vallath, Dublin, CA (US)

(73) Assignee: Apple Inc., Cupertino, CA (US)

(21) Appl. No.: 18/789,669

(22) Filed: Jul. 30, 2024

(51) Int. Cl. H04L 5/00

(52) U.S. Cl. CPC H04L 5/0057; H04L 5/0048

(57) ABSTRACT

The present application relates to channel state information (CSI) signaling and computing. In an example, a network configures a user equipment (UE) with multiple CSI configurations including a CSI Type I configuration and a CSI Type II configuration. Based on a set of factors, the network and/or the UE can dynamically determine the CSI configuration from among the multiple CSI configurations that is most suitable to use. When generating a CSI report, this CSI configuration is used. Further, in the case of the CSI Type II configuration being used for the CSI report, the UE can use information derived from using the CSI Type I configuration to reduce the complexity of the CSI Type II computations.

### BACKGROUND

Cellular network coverage can enable communications between a user equipment and a cellular network. Generally, a downlink channel and an uplink channel can be established and used for the communications between the user and the cellular network. The communication quality associated with using a channel (e.g., a downlink channel for data reception) can depend on the quality of the channel. The cellular network (e.g., a base station thereof) can use information about the channel's quality to manage various aspects of using the channel.

### BRIEF DESCRIPTION OF THE DRAWINGS

FIG. 1 illustrates a network environment, in accordance with some embodiments.

FIG. 2 illustrates an example of a sequence diagram that involves using channel state information (CSI), in accordance with some embodiments.

FIG. 3 illustrates an example of data processing in support of a transmission based on CSI, in accordance with some embodiments.

FIG. 4 illustrates an example of an antenna panel that supports multiple layers, in accordance with some embodiments.

FIG. 5 illustrates an example of a plot showing link throughputs based on different CSI types, in accordance with some embodiments.

FIG. 6 illustrates an example of a user equipment (UE) configured to determine a CSI type for CSI reporting, in accordance with some embodiments.

FIG. 7 illustrates an example of a sequence diagram that involves a UE-based determination of a CSI type for CSI reporting, in accordance with some embodiments.

FIG. 8 illustrates an example of an operational flow/algorithmic structure implemented by a UE to determine a CSI type for CSI reporting, in accordance with some embodiments.

FIG. 9 illustrates an example of a base station configured to determine a CSI type for CSI reporting, in accordance with some embodiments.

FIG. 10 illustrates an example of a sequence diagram that involves a base station-based determination of a CSI type for CSI reporting, in accordance with some embodiments.

FIG. 11 illustrates another example of a sequence diagram that involves a base station-based determination of a CSI type for CSI reporting, in accordance with some embodiments.

FIG. 12 illustrates yet another example of a sequence diagram that involves a base station-based determination of a CSI type for CSI reporting, in accordance with some embodiments.

FIG. 13 illustrates an example of a plot showing link throughputs based on different CSI computations, in accordance with some embodiments.

FIG. 14 illustrates an example of a UE configured to support different CSI computations, in accordance with some embodiments.

FIG. 15 illustrates an example of a sequence diagram that involves CSI computations, in accordance with some embodiments.

FIG. 16 illustrates an example of an operational flow/algorithmic structure implemented by a UE for a UE-based CSI type determination, in accordance with some embodiments.

FIG. 17 illustrates an example of an operational flow/algorithmic structure implemented by a base station for a UE-based CSI type determination, in accordance with some embodiments.

FIG. 18 illustrates an example of an operational flow/algorithmic structure implemented by a UE for a base station-based CSI type determination, in accordance with some embodiments.

FIG. 19 illustrates an example of an operational flow/algorithmic structure implemented by a base station for a base station-based CSI type determination, in accordance with some embodiments.

FIG. 20 illustrates an example of an operational flow/algorithmic structure implemented by a UE for UE-based CSI computations, in accordance with some embodiments.

FIG. 21 illustrates an example of an operational flow/algorithmic structure implemented by a base station for UE-based CSI computations, in accordance with some embodiments.

FIG. 22 illustrates an example of receive components, in accordance with some embodiments.

FIG. 23 illustrates an example of a UE, in accordance with some embodiments.

FIG. 24 illustrates an example of a base station, in accordance with some embodiments.

### DETAILED DESCRIPTION

Embodiments of the present disclosure are directed to, among other things, channel state information (CSI) signaling and computing. Generally, a network (e.g., a base station thereof) can configure a periodic CSI reference signal (CSI-RS) for a user equipment (UE). The network can also send configuration information to the UE indicating a CSI Type I configuration and a CSI type II configuration (including CSI enhanced Type II (eType II) configuration). Using the CSI Type I configuration and/or the CSI Type II configuration for CSI reporting can be dynamic and can depend on a number of factors. In an example, the UE can determine which of the two configurations is recommended based on a set of factors and can indicate this recommendation to the network. In turn, the network can determine whether to proceed with or override the recommendation and can indicate this determination to the UE. The UE accordingly generates a CSI report. In another example, rather than the UE generating and sending a recommendation, the base station can generate a decision to use the CSI Type I configuration or the CSI Type II configuration based on a set of factors and can indicate the selected configuration to the UE. Here also, the UE generates the CSI report accordingly. Possibly, the base station can determine that the UE needs to generate the decision. In this case, the UE can indicate whether the CSI Type I configuration or the CSI Type II configuration was selected in the CSI report itself. The factors can include any or a combination of a throughput capacity, a Doppler metric, a reference signal measurement, a relative UE-to-base station position, a UE resource limitation, and/or a network load. The decision can also be generated by an artificial intelligence (AI)-machine learning (ML) model, which can be executed by the UE and/or the base station.

In an additional example, when computing various features of a CSI report corresponding to the CSI Type II configuration (including, for instance, a rank indicator (RI)), the UE can initially use the CSI Type I configuration and the result of the CSI Type I configuration-based computations can be used in computing features of the CSI report. Generally, the CSI Type I configuration-based computations are less complex than the CSI Type II configuration-based computations. By doing so, the features can be computed more efficiently and at a lower latency. In a particular illustration, a first RI is determined using the CSI Type I configuration-based computations. When performing the CSI Type II configuration-based computations, these computations can be limited to the first RI and/or an adjacent RI that is larger than the first RI (e.g., the set of {first RI, first RI+1}), without a significant impact to a throughput capacity (e.g., a difference in throughput capacity that is minimal, non-existent, or within an acceptable margin). Particularly, rather than searching all CSI Type II codebooks, this search can be constrained to the CSI Type II codebooks corresponding to the first RI and/or the adjacent RI.

In the interest of clarity of explanation, various embodiments of the present disclosure are described in connection with a new radio (NR) fifth generation (5G) cellular network. However, the embodiments may not be limited as such and can apply to other types of wireless networks including, for instance, fourth generation (4G) cellular networks and/or sixth generation (6G) cellular networks.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processing circuitry” as used herein refers to, is part of, or includes circuitry capable of sequentially and automatically carrying out a sequence of arithmetic or logical operations, or recording, storing, or transferring digital data. The term “processing circuitry” may refer to an application processor, a baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The terms “device” and “user equipment (UE)” as used herein refers to a wired and/or wireless computing device with radio communication capabilities and that may use network resources in a communications network. The terms “device” and “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc.

The term “base station” as used herein refers to a device with radio communication capabilities, that is a network component of a communications network (or, more briefly, a network), and that may be configured as an access node in the communications network. A device's access to the communications network may be managed at least in part by the base station, whereby the UE connects with the base station to access the communications network. Depending on the radio access technology (RAT), the base station can be referred to as a gNodeB (base station), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “connected” may mean that two or more elements, at a common communication protocol layer, have an established signaling relationship with one another over a communication channel, link, interface, or reference point.

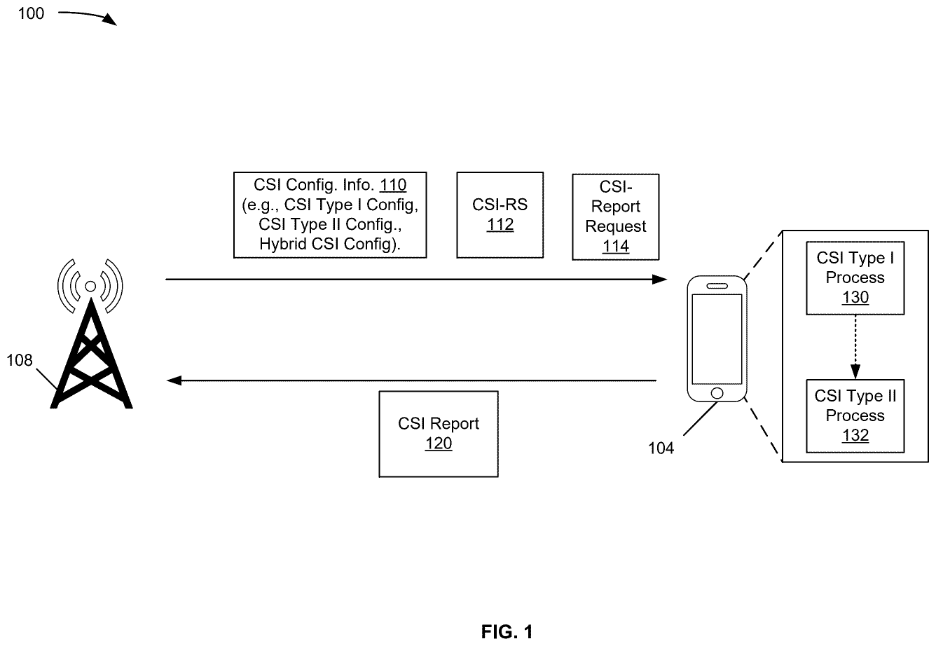

FIG. 1 illustrates a network environment 100, in accordance with some embodiments. The network environment 100 may include a UE 104 and a base station 108. The base station 108 may provide a wireless access cell; for example, a Third-Generation Partnership Project (3GPP) cell (e.g., new radio (NR) 5G cell) through which the UE 104 may communicate with the base station 108. This base station may be a component of a network (e.g., a 3GPP cellular network). The UE 104 and the base station 108 (e.g., a gNB) may communicate over an interface compatible with 3GPP technical specifications.

As further described in the next figures, the base station 108 can send CSI configuration information 110 to the UE 104. The CSI configuration information 110 can indicate, among other things, a periodic CSI-RS configuration, a CSI Type I configuration, a CSI Type II configuration (possibly including a CSI eType II configuration), and/or a hybrid CSI configuration. The hybrid CSI configuration can enable the UE to select a CSI configuration from CSI Type I configuration and the CSI Type II configuration and use the selected configuration to generate a CSI report. Periodically, the base station 108 can transmit a periodic CSI-RS 112. The base station 108 can also transmit a CSI-report request 114 (e.g., for aperiodic CSI reporting) to the UE 104. Using one or both of a CSI Type I process 130 and/or a CSI type II process 132, the UE can generate a CSI report 120 based on the CSI-RS 112 and the CSI type I configuration, the CSI type II configuration, or the hybrid configuration. The CSI report 120 can be sent to the base station 108.

In an example, the UE 104 can recommend whether the CSI Type I configuration or the CSI Type II configuration needs to be used for generating the CSI report based on a number of factors. The base station 108 can instruct the UE 104 to proceed accordingly or can override the recommendation. In another example, the base station 108 itself can generate the decision whether the CSI Type I configuration, the CSI Type II configuration, or optionally the hybrid CSI configuration needs to be used for generating the CSI report based on a number of factors and can instruct the UE 104 to do so. Furthermore, if the decision is to use the CSI type II configuration (regardless of whether the UE 104 recommends this use or the base station 108 directly decides using this configuration), the UE 104 can execute the CSI Type I process 130 to complete CSI Type I-based computations and use the outcome thereof as input to the CSI Type II process 132. This input can be used to constrain the CSI Type II-based computations of the CSI Type II process 132 such that these computations can become more efficient without a significant impact to the link throughput.

In an example, the CSI-RS 112 is sent on a downlink channel. The base station 108 can receive and use the CSI report 112 to optimize and enhance the efficiency of the downlink channel (and possibly of an uplink channel if channel reciprocity is assumed). The CSI report 112 provides information about the downlink channel by including parameters such as a channel quality indicator (CQI—indicating the quality of the channel), a precoding matrix indicator (PMI—providing information about the preferred precoding matrix, which is used for beamforming and spatial multiplexing, allowing the base station 108 to adjust the antenna array to maximize signal strength and quality), a rank indicator (RI—indicating the number of spatial layers that can be supported, which helps in determining the number of data streams to use), and/or CSI-RS measurements (allowing the base station 108 to more accurately evaluate the channel conditions). This information can enable the base station 108 to, among other things, adjust the modulation and coding schemes dynamically, maximize data throughput, maintain reliable communication, and control its beamforming.

The base station 108 may transmit information (for example, data and control signaling) in the downlink direction by mapping logical channels on the transport channels, then transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH); a physical downlink control channel (PDCCH); and a physical downlink shared channel (PDSCH).

The PBCH may be used to broadcast system information that the UE 104 may use for initial access to a serving cell. The PBCH may be transmitted along with primary synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data, signaling radio bearer (SRB) messages, system information messages (other than, for example, MIB), and paging messages.

The PDCCH may transfer downlink control information (DCI) that is used by a scheduler of the base station 108 to allocate both uplink and downlink resources. The DCI may also be used to provide uplink power control commands, configure a slot format, or indicate that preemption has occurred.

The base station 108 may also transmit various reference signals to the UE 104. The reference signals may include demodulation reference signals (DM-RSs) for the PBCH, PDCCH, and PDSCH. The UE 104 may compare a received version of the DMRS with a known DM-RS sequence that was transmitted to estimate an impact of the propagation channel. The UE 104 may then apply an inverse of the propagation channel during a demodulation process of a corresponding physical channel transmission.

The reference signals may also include CSI-RS. The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain, and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs; for example, six REGs.

The UE 104 may transmit data and control information to the base station 108 using physical uplink channels. Different types of physical uplink channels are possible, including a physical uplink control channel (PUCCH) and a physical uplink shared channel (PUSCH). Whereas the PUCCH carries control information from the UE 104 to the base station 108, such as uplink control information (UCI), the PUSCH carries data traffic (e.g., end-user application data) and can carry UCI.

In an example, communications with the base station 108 can use channels in the frequency range 1 (FR1) band and/or frequency range 2 (FR2) band, although other frequency ranges are possible. The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device applies a clear channel assessment (CCA) check before using the channel.

The base station 108 and the UE 104 can support multiple input multiple output (MIMO) communications. In an example, when the network load is small (e.g., the number of UEs communicatively coupled with the base station 108 and operating in an RRC_CONNECTED mode is below a threshold), the MIMO communications can use single user MIMO (SU-MIMO) technology. Otherwise, the MIMO communications can use multiple user MIMO (MU-MIMO) technology. In both cases, embodiments of the present disclosure relate to reporting CSI for large, massive MIMO systems with multiple reporting configurations.

Generally, to meet the huge demand for data centric applications, 3GPP extended the fourth generation long term evolution (LTE) systems to 5G NR systems. The following were the requirements for 5G NR networks: data rates of several tens of megabits per second should be supported for tens of thousands of users, one gigabit per second to be offered simultaneously to tens of co-located users (e.g., on a same floor of a building), several hundreds of thousands of simultaneous connections to be supported for massive sensor deployments, spectral efficiency should be significantly enhanced compared to 4G LTE networks, coverage should be improved, signaling efficiency should be enhanced, and latency should be reduced significantly compared to 4G LTE networks.

Similar to the 4G LTE systems, the 5G NR networks also use CSI reporting to manage aspects of the communications (including MIMO communications) to meet these requirements. Two types of CSI configurations are defined: a CSI Type I configuration and a CSI Type II configuration. While CSI based on the CSI Type I configuration is relatively less complex to compute, the CSI Type II configuration offers more granular information and can at least help with improving beamforming. Particularly, using the CSI Type I configuration can be more advantageous than using the CSI Type II configuration in the SU-MIMO scenario, without the added computation complexity of CSI Type II. CSI Type I can be better suited for the MU-MIMO scenario.

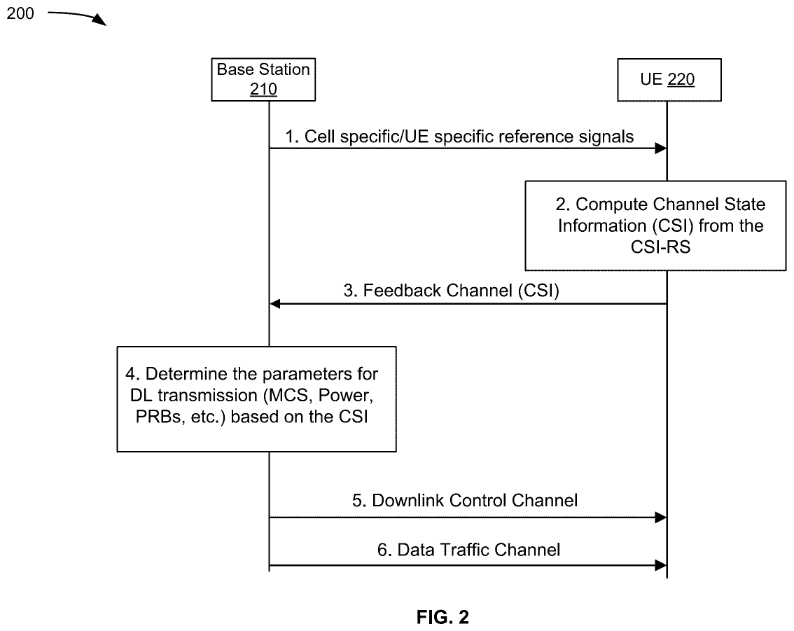

FIG. 2 illustrates an example of a sequence diagram 200 that involves using CSI, in accordance with some embodiments. Steps of the sequence diagram 200 can be executed by a base station 210 (an example of the base station 108) and a UE 220 (an example of the UE 104). The CSI can be computed based on a CSI Type I configuration or a CSI Type II configuration.

As illustrated, the base station 210 sends cell specific reference signals and/or UE specific reference signals. An example of a reference signal is CSI-RS. It is possible that a pilot signal can be sent. From the pilot or reference signals, the UE 220 computes the channel estimates then computes the parameters needed for CSI reporting. The CSI report include, for example, CQI, PMI, RI, CSI-RS Resource Indicator (CRI) etc. The UE 220 then sends the CSI report is sent to the network (e.g., the base station 210) via a feedback channel either on request from the network (e.g., when the CSI reporting is configured as aperiodic CSI reporting) or configured to report periodically. The network scheduler (e.g., a component of the base station 210) uses the reported CSI to choose parameters for scheduling communications of the UE 220 (e.g., at least for a downlink channel). These parameters can include MCS, power transmission level, physical resource block (PRB) allocations, etc. The network (e.g., the base station 210) sends the scheduling parameters to the UE 220 in a downlink control channel (e.g., PDCCH). After that actual data transfer can take between the network (e.g., the base station 210) and the UE 220 (e.g., at least on a downlink channel such as PDSCH).

Downlink reference signals are predefined signals occupying specific resource elements within the downlink time-frequency grid. There are several types of downlink reference signals that are transmitted in different ways and used for different purposes by the receiving terminal including CSI-RS and DM-RS. A CSI-RS can be specifically intended to be used by terminals to acquire CSI) and beam specific information (a beam's reference signal received power (RSRP)). In 5G, CSI-RS is UE specific so it can have a significantly lower time/frequency density. DM-RS can also be sometimes referred to as a UE-specific reference signal, can be specifically intended to be used by terminals for channel estimation for data channel. The label “UE-specific” relates to the fact that each demodulation reference signal is intended for channel estimation by a single terminal. That specific reference signal is then only transmitted within the resource blocks assigned for data traffic channel transmission to that terminal. Oher reference signals, such as multimedia broadcast multicast service single frequency network (MBSFN) reference signals and positioning reference signals, can be used for various purposes.

In comparison, an uplink control channel (e.g., PUCCH) can be used to send CSI and information about HARQ-ACK information corresponding to the downlink data transmission. The CSI can be divided into two categories. One is for subband and the other one is for wideband. The configuration of subband or wideband CSI reporting can involve radio resource control (RRC) signaling as part of CSI reporting configuration. Table 1 below shows the contents of CSI report for “PMI format indicator=Wideband,” “CQI format indicator=wideband” and for” PMI format indicator=subband,”” CQI format indicator=subband.”

TABLE 1

| PMI- | PMI-FormatIndicator = subbandPMI or | | |
|---|---|---|---|
| FormatIndicator = widebandPMI | CQI-FormatIndicator = subbandCQI | | |
| and CQI- | | CSI Part II | |
| FormatIndicator = widebandCQI | CSI Part I | wideband | subband |
| CRI | CRI | Wideband CQI | Subband |
| | | for the second TB | differential CQI |
| | | | for the second TB |
| | | | of all even |
| | | | subbands |
| Rank Indicator | Rank Indicator | PMI wideband | PMI subband |
| | | (X1 and X2) | information fields |
| | | | X₂ of all even |
| | | | subbands |
| Layer Indicator | Layer Indicator | — | Subband |
| | | | differential CQI |
| | | | for the second TB |
| | | | of all odd |
| | | | subbands |
| PMI wideband (X1 and X2) | Wideband CQI | — | PMI subband |
| | | | information fields |
| | | | X₂ of all odd |
| | | | subbands |
| Wideband CQI | Subband | — | — |
| | differential CQI | | |
| | for the first TB | | |

For 5G NR, the subband can be defined according to the bandwidth part of the OFDM in terms of PRBs as shown in Table 2 below. The subband configuration can also signaled through RRC signaling.

TABLE 2

| Carrier bandwidth | Subband |
|---|---|
| part (PRBs) | Size (PRBs) |
| <24 | N/A |
| 24-72 | 4, 8 |
| 73-144 | 8, 16 |
| 145-275 | 16, 32 |

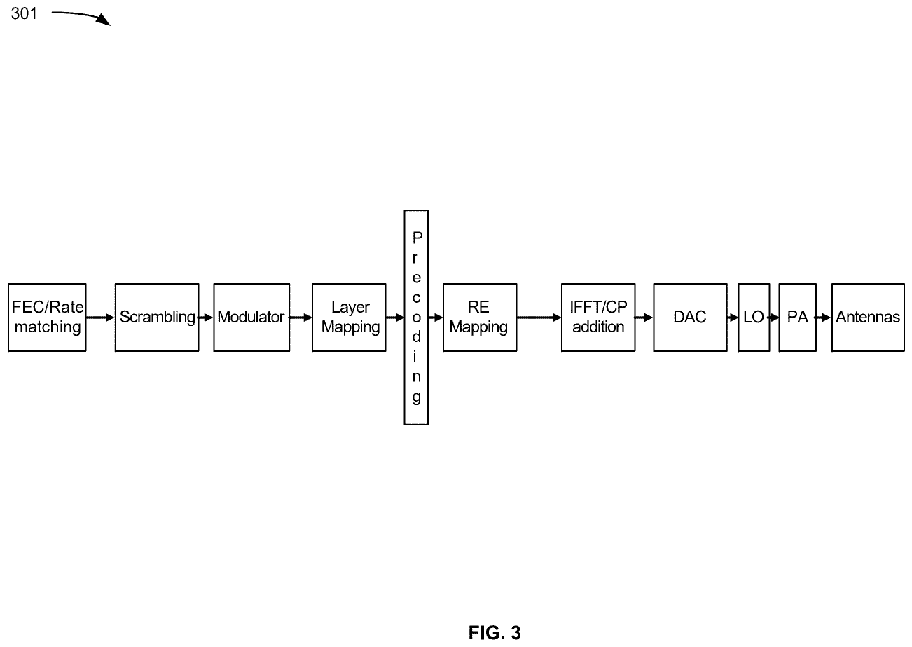

FIG. 3 illustrates an example of data processing 300 in support of a transmission based on CSI, in accordance with some embodiments. As illustrated, input bits are passed through a forward error correction code unit where additional parity bits are added for error protection. The resultant bits are passed through a scrambling unit which adds cell-specific scrambling operation for interference avoidance from neighboring cells. The resultant bits are passed through a modulator unit which converts the bitstream to complex symbols. The resultant symbols are passed through a layer mapper unit which maps the resultant modulated symbols to different layers. The resultant symbols per layer are multiplied by a baseband precoder unit (e.g., using precoding weights) and are mapped by a resource element mapping unit to resource elements assigned to a user equipment.

In the radio unit, the resultant streams are passed through inverse fast Fourier transform (IFFT) and cyclic prefix (CP) unit for converting from frequency domain to time domain. Note that IFFT block is applied for each baseband port. As such, if thirty-two baseband ports are sed, thirty-two IFFT blocks are needed. The resultant time-domain signals per branch are passed through a digital to analog converter (DAC) unit for converting to the analog domain. The resultant analog signal is multiplied by an analog signal generated from a local oscillator (LO) unit and passed through a power amplifier unit for amplification and then transmitted by one or more antennas.

The above data processing 300 corresponds to sending data from a transmitting device (e.g., from a base station). Inverse data processing can be used by a receiving device (e.g., a UE) to process the received signal and generate the corresponding bits. Each unit can be implemented in hardware and/or software.

When the data the data processing 300 is performed by the base station, CSI can be used. For instance, RI can be used in the layer mapping unit, where the number of layers (e.g., data streams) can correspond to the RI. PMI can be used in the precoder unit (e.g., using weights defined by the corresponding codebook(s) for beamforming).

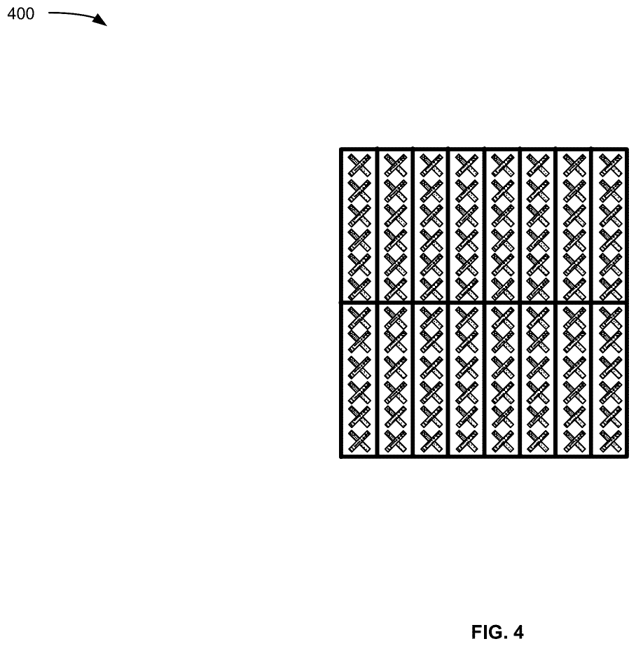

FIG. 4 illustrates an example of an antenna panel 400 that supports multiple layers, in accordance with some embodiments. The antenna panel 400 can support MIMO technology (e.g., where each layer can correspond to one of the MIMO data streams and is mapped to a specific subset of antennas of the antenna panel 400, where this subset is controlled for beamforming).

MIMO systems can significantly increase the throughput of wireless systems. Therefore, MIMO technology is implemented in many wireless systems. In fact, 5G NR systems employ MIMO systems with many antennas, known as massive MIMO systems (also referred to as active antenna systems). Typically, a massive MIMO system is set up with Nₜ transmit and receive antennas, also called Nₜ Transmit and Receive (TR). For example, a thirty-two TR system consists of thirty-two baseband ports and thirty-two radio branches.

As an example of massive MIMO systems, supporting one-hundred ninety-two antenna elements (AE) implemented at a base station for the frequency range of 3-4 GHz is shown in the antenna panel 400. The antenna panel 400 includes eight columns and two rows with x-polarization. (e.g., “8×2×2×6=192” AE). The eight columns cover the azimuthal gain for the UEs. The two rows provide the elevation gain. Hence, with the deployment of massive MIMO systems, the network (e.g., the base station thereof) can provide beamforming gain in both azimuthal and elevation domains.

A beam can be formed by using a subset of the AE, where the use relies on precoding (e.g., weights defined by a codebook and used to control the transmit powers of the AE). Multiple beams can be simultaneously formed and can be used for MIMO-based communications with the same UE. The beamforming can use at least some of the CSI.

Ideal linear precoding needs full CSI at a transmitter, which may be possible for time division duplex (TDD) based systems but not practical for frequency division duplex (FDD) based systems. Codebook based precoding allows the receiver to explicitly identify a precoding matrix/vector based on a codebook that should be used for transmission. As an example, in 3GPP 5G NR standard, separate codebooks are defined for various combinations of the number of transmit antennas and the number of transmission layers. The latter can be referred to as RI.

Generally, the 3GPP 5G NR standard defines two types of precoder codebooks: Type-I CSI and Type-II CSI. Type-I CSI codebooks are designed to be straightforward, focusing primarily on directing transmitted energy towards the intended receiver. The assumption is that any interference among multiple parallel transmission layers can be managed by the receiver's processing capabilities, which leverage several receiving antennas. In comparison, Type-II CSI codebooks offer a more detailed framework, enabling PMI to deliver data with finer spatial details. This facilitates the network to optimize downlink precoders that concentrate energy on the target device while minimizing interference with other devices that share the same spectral resources for example in MU-MIMO scenarios. The detailed PMI feedback in Type II CSI, however, results in substantially increased signaling demands. For instance, while Type I CSI might need a PMI report with just a few dozen bits, Type II CSI could need a PMI report encompassing several hundred bits, reflecting its complexity and greater information depth. Furthermore, the 3GPP 5G NR standard defines Type I CSI up to eight layers in its Release 15 and Type II CSI up to two layers in its Release 15 and is extended up to four layers in its Release 16. The later release of Type II CSI is also called eType II CSI. CSI Type I can also be referred to as CSI type I, CSI Type 1, CSI Type-I, CSI Type-1, CSI type-I, or CSI type-1. Similarly, CSI Type II can also be referred to as CSI type II, CSI Type 2, CSI Type-II, CSI Type-2, CSI type-II, or CSI type-2. CSI eType II can also be referred to as CSI etype II, CSI eType 2, CSI eType-II, CSI eType-2, CSI etype-II, or CSI etype-2.

When a UE is configured to utilize eType II CSI reporting, it needs to transmit this information via an uplink shared channel (e.g., PUSCH). Typically, the data payload for eType II CSI is substantial, often encompassing several hundred bits. This significant data overhead translates into considerable resource utilization within the uplink shared channel, which could otherwise be allocated to user data transmission or other critical signaling tasks (and thereby impacting at least the uplink data throughput).

The extensive overhead associated with eType II CSI reporting is not without its challenges. Primarily, the system resource allocation for this reporting can become inefficient, especially when the performance gains from eTypeII CSI are not distinctly superior to those achieved with simpler Type-I CSI reporting systems. Type I CSI, being less complex, consumes far fewer resources and offers a more straightforward approach to channel state reporting that can be sufficient under various network conditions.

However, eType II CSI provides more detailed CSI, which can be beneficial for optimizing system performance in environments where precise beamforming and advanced signal processing techniques are necessary (e.g., in MU-MIMO scenarios). This detailed feedback helps in fine-tuning the downlink transmission strategies to enhance spectral efficiency and reduce interference among users in dense network deployments.

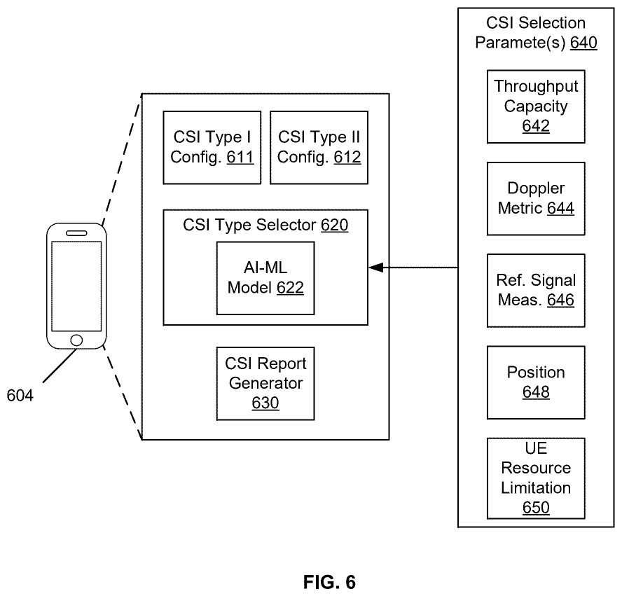

Given these considerations, there is a compelling need for a hybrid CSI reporting system that combines the advantages of both Type I and eType II CSI. Such a hybrid system would aim to dynamically select the CSI reporting type based on current channel conditions, network congestion levels, and the specific needs of the UE and/or the base station. Embodiments related to such a system are shown in FIGS. 6-12. Before describing these embodiments, herein next is a performance comparison of using CSI Type I reporting and CSI eType II reporting. As shown, the performances are similar under certain conditions, whereas the performance of using the CSI eType II CSI reporting is relatively better under other conditions. The are reflected in the signal to noise ratio SNR. As such, the hybrid CSI system can optimize resource and performance by selectively using the CSI Type I reporting or CSI Type II (e.g., eType II) reporting based on the conditions.

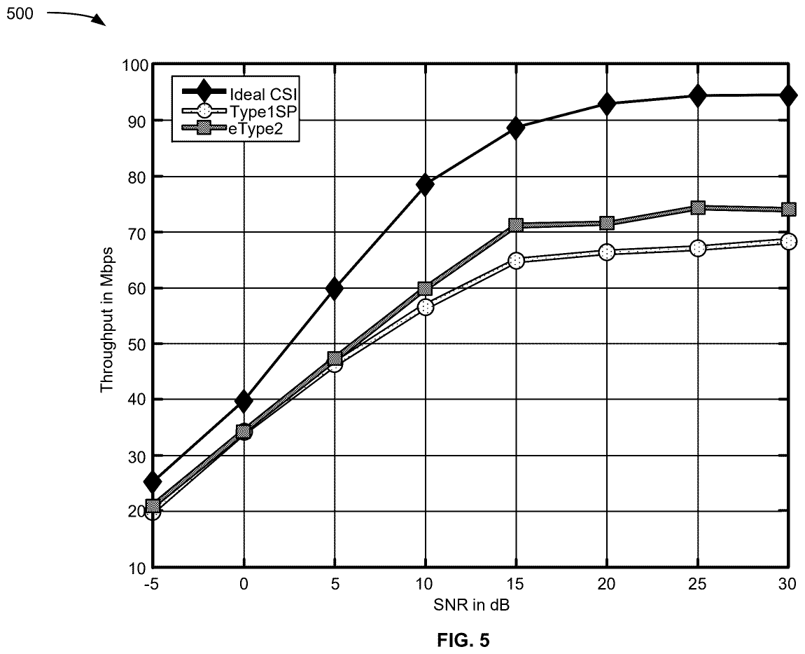

FIG. 5 illustrates an example of a plot 500 showing link throughputs based on different CSI types, in accordance with some embodiments. The vertical line of the plot 500 correspond to the throughput in Mbps (e.g., a link throughput). The horizontal line of the plot 500 corresponds to the SNR in dB. The plot 500 shows the throughput as a function of the SNR in three CSI reporting use cases: for using ideal CSI (labeled with “ideal CSI”), for using CSI Type I (labeled with “Type1SP”) and for using CSI eType II (labeled with “eType2”).

The plot 500 is generated using a simulation, where the UE is configured with thirty-two port CSI-RS and requesting Type I CSI report only and the other case with eType II CSI report only. The remaining simulation assumptions are shown in Table 3.

TABLE 3

| | |
|---|---|
| Assumptions | Value |

| Carrier frequency | 3.5 | GHz |
|---|---|---|
| Duplex | FDD/TDD | |
| System Bandwidth | 25 | PRB |
| Slot length | 14 OFDM symbols | |
| Subcarrier spacing | 30 | KHz |
| FFT size | 4096 | |
| Data transmission bandwidth | 25 RB for 30 KHz spacing | |
| Antenna configuration | (32, 4) | |
| Number of codewords | 1 | |
| Channel encoder | LDPC code (BG1 and BG2) | |
| MCS | Link adaptation | |
| Control Overhead | 2 symbols | |
| Channel estimation | Practical | |
| UE speed | 3 | Kmph |

| | |
|---|---|
| Channel Model | CDL-C with delay |
| | spread 300e−9 sec |

It can be observed that, even though eType II provides gains at medium to high SNR, the gains at low SNR (e.g., less than 5 dB) are not significant. In fact, in most of the low SNR cases the link throughput resulting from using the CSI eType II reporting for controlling the downlink transmission can almost be equal to that of using Type I CSI. In these low SNR cases, Type I CSI is better as it involves less overhead (a smaller number of bits) for reporting the CSI parameters and less computation to generate the CSI report. On the other hand, eType II necessitates significant overhead (a larger number of bits) and may not be more useful from the system point of view. Hence, if the UE or the network (e.g., a base station thereof) can determine if Type I CSI is better or eType II (or, more generally, Type II), is better for the current channel conditions, significant performance can be achieved with less overhead in the uplink.

FIG. 6 illustrates an example of a UE 604 configured to determine a CSI type for CSI reporting, in accordance with some embodiments. The UE 604 is an example of the UE 104 of FIG. 1. Generally, the configuration allows simplifying the process of generating CSI (e.g., determining the PMI included in a CSI report). Particularly, the UE 604 can be configured with multiple CSI reporting configurations where at least one reporting configuration corresponds to Type I CSI and the other one corresponds to Type II CSI (e.g., possibly eType II CSI). The UE 604 can use different factors (e.g., including an estimation of the best achievable throughput capacity from the channel estimated by processing CSI-RS according to Type I CSI or Type II CSI and determines it is better to use Type I CSI or Type II CSI). The UE 604 can indicate its recommendation to the network (e.g., a base station thereof) using an uplink control channel, or an uplink shared channel, or layer two (L2) signaling. Once the network receives this recommendation, it can request the CSI using a downlink control channel (for aperiodic CSI reporting), where this request can indicate whether to use the recommended CSI configuration or not.

In an example, the UE 604 stores in its memory configuration information indicating multiple CSI configurations including a CSI Type I configuration 611 and a CSI type II configuration 612. The CSI type II configuration 612 can possibly include a CSI eType II configuration. Although not illustrated in FIG. 6, the CSI configurations can further include a hybrid CSI configuration that allows the UE 604 to select using the CSI Type I configuration 611 and/or the CSI type II configuration 612. The configuration information can also indicate a configuration for CSI-RS (e.g., for periodic CSI-RS) and other aspects of CSI reporting.

The UE 604 can implement (e.g., as hardware and/or software) a CSI type selector 620. The CSI type selector 620 can select, based on one or more CSI selection parameters 640, a CSI type to recommend or use for generating a CSI report. The CSI type can correspond to a CSI configuration selected from the CSI Type I configuration 611 and the CSI type II configuration 612. In other words, if the CSI type selector 620 selects CSI type I, the CSI Type I configuration 611 would be used for generating the CSI report. Similarly, if the CSI type selector 620 selects CSI type II, the CSI Type II configuration 612 would be used for generating the CSI report.

Generally, based on the CSI selection parameter(s) 640, the UE 604 can determine which of the two CSI configurations (the CSI Type I configuration 611 and the CSI type II configuration 612) is more suitable or can result in better performance when the corresponding CSI report is used. If the CSI Type I configuration 611 is more suitable or can result in the better performance, the CSI Type I configuration 611 is selected and recommended to the network. Otherwise, the CSI Type II configuration 612 is selected and recommended to the network.

In an example, the CSI type selector 620 can implement an AI-ML model 630. The AI-ML model 630 can have been previously trained to select between the CSI Type I configuration 611 and the CSI Type II configuration 612 based on the CSI selection parameter(s) 640. In particular, the CSI selection parameter(s) 640 can be input to the AI-ML model 630 that outputs the selection. The training can use historical data that includes data pairs. A data pair can include known values of the CSI selection parameter(s) and the corresponding correct selection. The correct selection can be set as ground truth. The known values can be input to the AI-ML model 630. Its output can be compared to the correct selection. If the output matches the correct selection, a reward may be assigned. Otherwise, a penalty or loss can be assigned. The training can be iteratively repeated using the data pair and across more data pairs.

Furthermore, the UE 604 can include a CSI report generator 630 that generates a CSI report by using the CSI configuration selected by the CSI type selector 620 (e.g., the CSI Type I configuration 611 and/or CSI type II configuration 612) on the network (e.g., a base station). The CSI report can include PMI, CSI, RI, and other CSI-related information. Generating the CSI report can include various computation. For example, measurements can be performed on the CSI-RS for channel estimation. Based on the channel estimation, the UE can derive, CQI, PMI, and RI. Particularly, the selected CSI configuration can indicate a set of codebooks. These codebooks can be searched to determine an RI that gives the highest achievable throughput. The codebook corresponding to the RI can indicate PMI. Further, the UE can estimate the SNR and the SNR can be mapped to CQI.

In an example, the CSI selection parameter(s) 640 can include any or a combination of: a throughput capacity 642, a Doppler metric 644, a reference signal measurement 646, a position 648, or a UE resource limitation 650. Generally, the UE 604 can determine which CSI configuration likely results in a better performance and can select this CSI configuration.

In an example, the performance can be estimated based on the achievable throughput capacity (referred to as the throughput capacity 642). The UE 604 first estimates the channel and the noise plus interference covariance for the configured CSI-RS. The UE 604 can then calculate the capacity achievable with the CSI Type I configuration 611, denoted as “C1.” Similarly, the UE 604 estimates the capacity achievable with the CSI Type II configuration 612, denoted as “C2.” If the latter capacity is better (e.g., “C2>C1”), the UE 604 can select and recommend the CSI Type II configuration 612. Otherwise, the CSI Type I configuration 611 can be selected and recommended. Additionally, or alternatively, if the difference between the latter capacity and the formed capacity is larger than a threshold “D” (e.g., “C2−C1>D”), the UE 604 can select and recommend the CSI Type II configuration 612. Otherwise, the CSI Type I configuration 611 can be selected and recommended. It is possible that the UE 604 can recommend one of the two CSI configurations (e.g., based on the capacity comparison) and the network selects the recommended CSI configuration or the other one (e.g., based on the comparison of their difference to the threshold “D”). The threshold “D” can be predefined in a technical specification that the UE 604 and the base station are compatible with, can be specific to the UE 604 or the base station, autonomously set by the UE 604, and/or can be indicated to the UE 604 in signaling from the base station (e.g., included as a parameter in the configuration information). Generally, the CSI Type II configuration is recommended only if its capacity advantage is significantly high. In one illustration of this approach, the UE can compute the CQI corresponding to each of the two CSI configurations. Each CQI can indicate the corresponding achievable capacity. The difference between the CQIs can be used to select or compared to the threshold “D” to select the CSI configuration.

In an example, the performance can be estimated based on the Doppler metric 644 of the UE 604. In this method, the UE 604 determines its Doppler metric 644, which can be an indication of the UE's 604 speed. If the Doppler metric 644 is less than a predefined threshold (also preset or indicated by the network), then the CSI Type II configuration 612 is recommended because it is known to perform better at lower speeds. Otherwise, the CSI Type I configuration 611 is deemed better for the current channel conditions. The Doppler metric 644 can be computed as the rate of change to the channel estimation. Particularly, the UE 604 can monitor the channel estimation (derived from CSI-RS measurements) over time to determine the rate of change and can set this rate as the Doppler metric 644. Additionally, or alternatively to computing the Doppler metric 644, the UE 604 can determine its speed (e.g., by monitoring change to its location over time) and compare the speed to a threshold. Here also, a low speed (e.g., one below the threshold) results in selecting the CSI Type II configuration 612. Otherwise, the CSI Type I configuration 611 is selected.

In an example, the performance can be estimated based on the reference signal measurement 646. The reference signal measurement 646 can be RSRP determined from the CSI-RS from SSB. If the RSRP is above a predefined threshold (also preset or indicated by the network), suggesting proximity to the cell center where signal strength is stronger, the CSI Type II configuration 612 can be selected and recommended. Conversely, the CSI Type I configuration 611 can be preferred if the UE 604 is closer to the cell edge or in the middle range (e.g., the RSRP being smaller than the threshold), where signal strength is weaker.

In an example, the performance can be estimated based on the position 648. The position 648 can be the relative position (e.g., possibly the relative distance) between the UE 604 and a base station (or a reference point of a serving cell). As illustrated in FIG. 5, the network can benefit from the CSI Type II configuration 612 primarily in conditions of high Signal-to-Noise Ratio (SNR), whereas the CSI Type I configuration 611 is sufficient for achieving beamforming gains at lower SNR levels. The UE 604 can estimate its position relative to the base station (e.g., through positioning technologies that involves the base station or other positioning systems such as a global position system (GPS)) and recommend the CSI Type I configuration 611 if the UE 604 is far from the base station, or the CSI Type II configuration 612 if the UE 604 is closer.

In an example, the performance can be estimated based on the UE resource limitation 650. This limitation 650 can relate to one or more components of the UE 604 that may impact the performance, such as the battery level or processing loads (e.g., usage of baseband processors). The limitation 650 can also relate to the carrier and carrier aggregation configuration that are assigned by the network and/or to other constraints related to resource allocation and/or data reception and/or data transmission. Generally, the larger or more severe the limitation 650 is, the more likely that the UE 604 recommends using the CSI Type I configuration 611. In a simple illustration, if the UE's 604 battery level is below a threshold (e.g., ten percent), the UE 604 recommends the CSI Type I configuration 611. Otherwise, the CSI Type II configuration 612 is recommended.

Once the UE 604 determines the type of the CSI it prefers (e.g., the recommended CSI configuration), the UE 604 needs to report this information to the network (e.g, the base station). In an example, the UE 604 reports this information by using layer one (L1) and/or Le signaling. L1 signaling can be as part of an uplink control channel or can be part of an uplink shared channel (e.g., PUCCH or PUSCH). L2 signaling can be as part of a media access control (MAC) control element (CE) signaling. In another example, the UE 604 can send this information as part of unused combinations or proprietary signaling. In yet another example, particular signaling can be defined in a technical specification with which the UE 604 and the base station comply.

In the case of a hybrid CSI configuration, rather than recommending a selected CSI configuration, the UE 604 can directly use this CSI configuration. In this case, the CSI report can indicate whether the CSI Type I configuration 611 or the CSI Type II configuration 612 was used. For example, one or more bits of the CSI report can set to have bit values indicating the CSI configuration.

Once the base station receives the UE's 604 recommendation about the CSI type (e.g. the recommended CSI configuration), the base station signals to the UE 604 (e.g., in DCI) the CSI type the base station prefers (e.g., whether the recommended CSI configuration is to be used for CSI reporting, or whether the other CSI configuration is to be used; the CSI reporting can be aperiodic, where the DCI can also request the CSI report). In one example, the base station uses the recommended CSI configuration. In another example, the base station can override the recommended CSI configuration by instructing the UE to use the other CSI configuration (e.g., if the UE 604 recommends the CSI Type I configuration 611, the base station can instruct the UE 604 to use the CSI Type II configuration 612, or vice versa). This decision to proceed with or override the recommended CSI configuration can use the same CSI selection parameters(s) 640 and/or other parameters (e.g., such as the network load, whereby if the number of UEs communicatively coupled with the base station and operating in an RRC_CONNECTED mode exceeds a threshold, base station can default to requesting the CSI Type II configuration 612).

Various advantages can result from using the approach of FIG. 6. For example, efficient use of uplink resources for reporting CSI at the same time without compromising on the performance of the system can be achieved. Furthermore, the battery life of a UE can be improved by optimizing the UE's component usage because the UE can get the same performance as that of eType-II standalone system by using a CSI Type I configuration in certain situations.

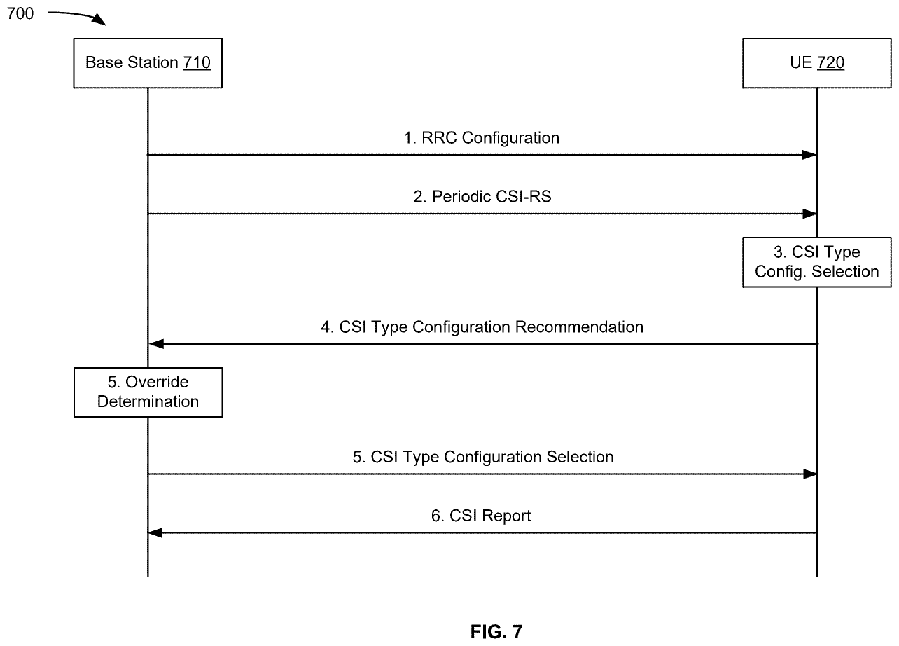

FIG. 7 illustrates an example of a sequence diagram 700 that involves a UE-based determination of a CSI type for CSI reporting, in accordance with some embodiments. Steps of the sequence diagram 700 can be executed by a base station 710 (an example of the base station 108) and a UE 720 (an example of the UE 104).

As illustrated, in a first step of the sequence diagram 700, the base station 710 sends an RRC configuration to the UE 720 (e.g., configuration information via RRC signaling). The RRC configuration corresponds to, among other things, the base station 710 indicating a periodic CSI-RS resource configuration and at least two aperiodic CSI reporting configurations, where one is for CSI reporting using CSI Type I and the other one is for CSI reporting using CSI Type II (possibly CSI eType II). In a second step, based on the periodic CSI-RS resource configuration, the base station 710 periodically sends CSI-RS to the UE 720 (e.g., in the configured resources).

In a third step of the sequence diagram, the UE 710 makes a CSI type configuration selection. Particularly, using one or more CSI selection parameters, similar to the ones described in FIG. 6, the UE 720 determines which configured CSI reporting is better (e.g., the one using the CSI Type I configuration or the CSI Type II configuration). The UE 720 selects the CSI reporting (or the corresponding CSI configuration) that is better. In a fourth step, the UE 720 sends a CSI type configuration recommendation. For instance, the UE 720 reports the selected CSI configuration to the base station 710 as a recommendation. The signaling described in FIG. 6 can be used to send this recommendation.

In a fifth step of the sequence diagram 700, based on the UE's 720 recommendation and possibly one or more CSI selection parameters, the base station 710 can determine whether to proceed with the UE-recommended CSI reporting (e.g., its recommended CSI configuration) or whether to override this recommendation and use the other CSI reporting (e.g., the other CSI configuration). Next, the base station 710 can indicate its CSI type configuration selection in a request for a CSI report. This request can be for aperiodic CSI reporting and can be sent in DCI that includes one or more bits having bit values indicating whether the CSI Type I configuration or the CSI Type II configuration is to be used. In a seventh step, the UE 720 generates and sends a CSI report accordingly to the base station 710.

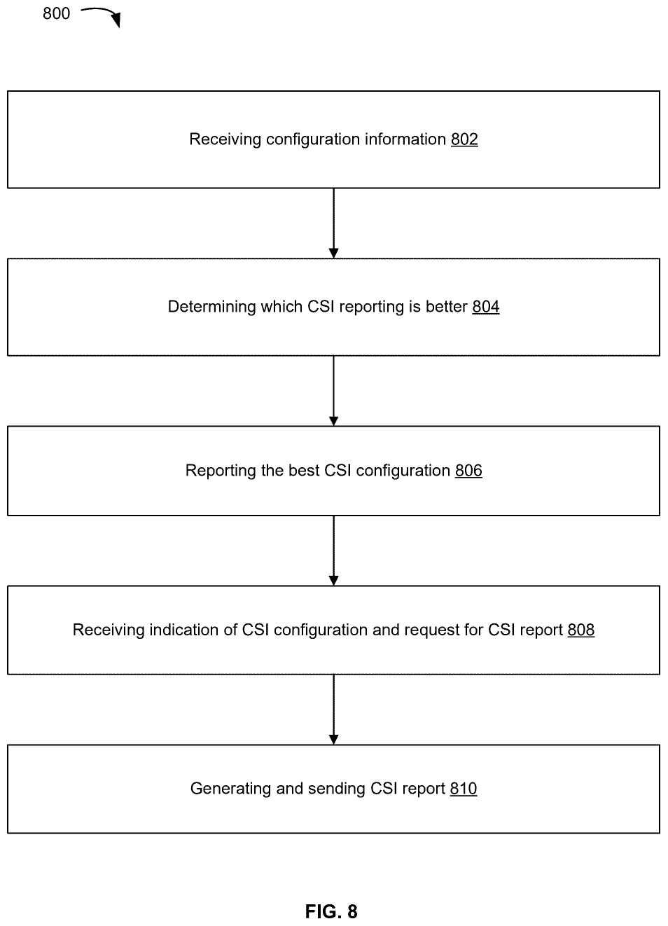

FIG. 8 illustrates an example of an operational flow/algorithmic structure 800 implemented by a UE (or an apparatus of the UE, where the apparatus includes processing circuitry) to determine a CSI type for CSI reporting, in accordance with some embodiments. The UE can be any of the UEs described herein. In some embodiments, the operational flow/algorithmic structure 800 may be implemented by executing instructions stored in a tangible, non-transitory, computer-readable storage medium, such as a memory of the UE. While the operational flow/algorithmic structure 800 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 800 includes at 802, receiving configuration information. For instance, RRC signaling can be received from a base station and can indicate a periodic CSI-RS configuration, a CSI Type I configuration, and a CSI Type II configuration (e.g., possible a CSI eType II configuration). Each CSI configuration (e.g., the CSI Type I configuration and the CSI Type II configuration) can be used resulting in a corresponding CSI reporting. As such, the RRC signaling can indicate different CSI reporting configurations.

In an example, the operational flow/algorithmic structure 800 includes at 804, determining which CSI reporting is better. For instance, the CSI selection parameter(s) 640 of FIG. 6 are used to determine whether the CSI Type I configuration or the CSI Type II configuration should be recommended to the base station.

In an example, the operational flow/algorithmic structure 800 includes at 806, reports the best CSI configuration. This CSI configuration is the recommended CSI configuration (e.g., selected from the CSI Type I configuration and the CSI Type II configuration based on the CSI selection parameter(s) 640). The signaling of FIG. 6 can be used to indicate the recommendation to the base station.

In an example, the operational flow/algorithmic structure 800 includes at 808, receiving an indication of a CSI configuration and a request for a CSI report. For instance, DCI is received from the base station and indicates whether the recommended CSI configuration or whether the remaining CSI configuration is to be used. The DCI can also request aperiodic CSI reporting.

In an example, the operational flow/algorithmic structure 800 includes at 810, generating and sending the CSI report. For instance, the CSI configuration indicated in the DCI is used to determine various features of the CSI report including PMI, RI, CQI. The CSI report is sent to the base station in an uplink channel.

Referring back to FIGS. 6-8, a UE-recommended CSI configuration is used. In the various examples, the UE need not generate a CSI report until instructed by a base station. However, it may be possible that the UE can initially generate multiple CSI reports, each corresponding to one of the CSI configurations. The UE can then recommend the use one of the CSI reports. Doing so may not optimize the UE resource usage, but can reduce the CSI reporting overhead by, for example, sending only the CSI report corresponding to the CSI Type I configuration if doing so is sufficient. Alternatively, the UE can initially generate a CSI report to the CSI Type I configuration. Based on this report, the UE can determine whether the performance is sufficient (e.g., the CQI is greater than a threshold). If so, the UE can recommend this CSI configuration and can proceed with sending it with the recommendation or upon a request of the base station. In this case, the UE only generates a CSI report to the CSI Type II configuration if subsequently requested by the base station.

Herein next, an additional or alternative approach to CSI is described. Rather than relying on a UE-recommended CSI configuration as described in FIGS. 6-8, the network (e.g., a base station thereof) can make an initial decision about the CSI configuration to use. The approach also corresponds to a hybrid CSI reporting approach that combines the advantages of both Type I and Type II CSI reports. This hybrid approach would optimize CSI reporting, minimizing overhead while maximizing the benefits of CSI feedback for efficient radio resource allocation and improved overall system performance.

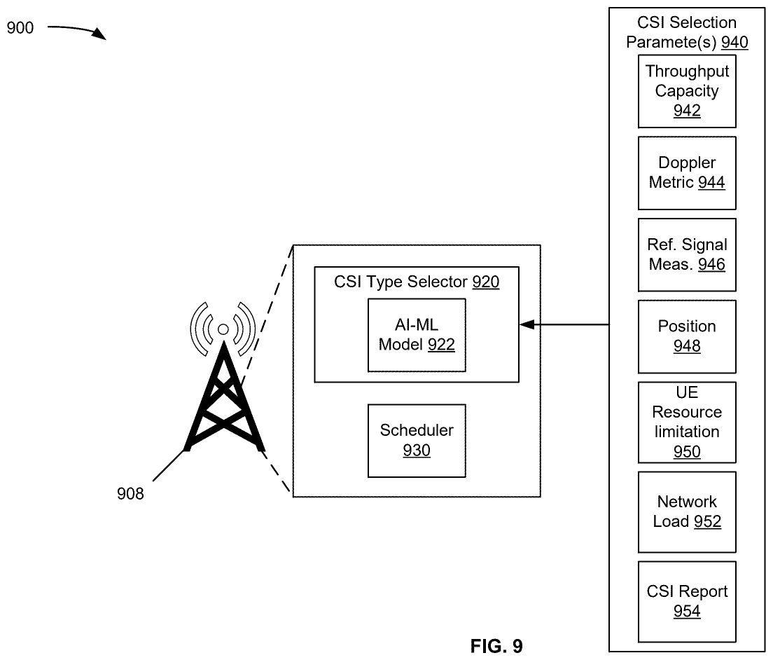

FIG. 9 illustrates an example of a base station 908 configured to determine a CSI type for CSI reporting, in accordance with some embodiments. The base station 908 is an example of the base station 108 of FIG. 1. Generally, the base station 908 can configure a UE (e.g., the UE 104 of FIG. 4) for periodic CSI-RS and aperiodic CSI reporting that uses a CSI Type configuration, a CSI Type II configuration, and/or a hybrid CSI configuration. The base station 908 can use different factors to select which of the configured CSI configurations (e.g., the CSI Type I configuration, the CSI Type II configuration, or the hybrid CSI configuration). The base station 908 can use different factors (illustrated as one or more CSI selection parameters 940) for the selection. Generally, the base station 908 can determine the better CSI configuration to use (e.g., the CSI Type I configuration or the CSI Type II configuration) and select this CSI configuration. If such a determination is not possible and if the hybrid CSI configuration is set up, the base station 908 can select the hybrid CSI configuration, thereby leaving the decision for using the CSI Type I configuration or the CSI Type II configuration to the UE. The base station 908 can indicate its selection in a request for aperiodic CSI reporting to the UE (e.g., in DCI).

In an example, the base station 908 can implement (e.g., as hardware and/or software) a CSI type selector 920. The CSI type selector 920 can select, based on the CSI selection parameter(s) 940, a CSI type for generating a CSI report (e.g, the better CSI configuration). If the CSI type selector 920 selects CSI type I, the CSI Type I configuration would be used for generating a CSI report. Similarly, if the CSI type selector 920 selects CSI type II, the CSI Type II configuration would be used for generating the CSI report. If the CSI type selector 920 selects the hybrid CSI configuration, the UE can then decide whether to use CSI Type I configuration or the CSI Type II configuration for generating a CSI report

Generally, based on the CSI selection parameter(s) 940, the base station 908 can determine which of the two CSI configurations (the CSI Type I configuration and the CSI type II configuration) is more suitable or can result in better performance when the corresponding CSI report is used. If the CSI Type I configuration is more suitable or can result in the better performance, the CSI Type I configuration is selected and indicated to the UE. If the CSI Type II configuration is more suitable or can result in the better performance, the CSI Type II configuration is selected and indicated to the UE. Otherwise, and if the hybrid CSI configuration is set up, the hybrid CSI configuration is selected and indicated to the UE.

In an example, the CSI type selector 920 can implement an AI-ML model 930. The AI-ML model 930 can have been previously trained to select between the CSI Type I configuration, the CSI Type II configuration, and, as applicable, the hybrid CSI configuration based on the CSI selection parameter(s) 940. In particular, the CSI selection parameter(s) 940 can be input to the AI-ML model 930 that outputs the selection. The training can use historical data that includes data pairs. A data pair can include known values of the CSI selection parameter(s) and the corresponding correct selection. The correct selection can be set as ground truth. The known values can be input to the AI-ML model 930. Its output can be compared to the correct selection. If the output matches the correct selection, a reward may be assigned. Otherwise, a penalty or loss can be assigned. The training can be iteratively repeated using the data pair and across more data pairs.

Furthermore, the base station 908 can include scheduler 930 that uses CSI (e.g., reported per the selected CSI configuration) to choose parameters for scheduling communications of the UE. These parameters can include MCS, power transmission level, PRB allocations, etc.

In an example, the CSI selection parameter(s) 940 can include any or a combination of: a throughput capacity 942, a Doppler metric 944, a reference signal measurement 946, a position 948, a UE resource limitation 950, a network load 952, or a CSI report 954. Generally, the base station 908 can determine which CSI configuration likely results in a better performance and can select this CSI configuration.

In an example, the performance can be estimated based on the achievable throughput capacity (referred to as the throughput capacity 942). Here, the base station 908 can receive from the UE a first CSI report 954 corresponding to the CSI Type I configuration and a second CSI report 954 corresponding to the CSI Type II configuration. The base station 908 determines the achievable throughput capacity with Type I CSI, denoted as “C1” (e.g., “C1=CQI₁×RI₁”, where “CQI₁” is the CQI received form Type I CSI report, “RI₁” is the rank information received from Type I CSI report). Similarly, the base station determines the capacity achievable with Type II CSI, denoted as “C2” (e.g., “C2=CQI₂×RI₂”, where “CQI₂” is the CQI received form Type II CSI report, “RI₂” is the rank information received from Type II CSI report). Additionally or alternatively, each throughput capacity can be estimated by using the channel estimation and the noise plus interference covariance for the configured CSI-RS. The base station 908 can opt for Type II CSI if the difference of the two capacities is larger than a threshold “D” (e.g., “C2−C1>D”), where D is a delta parameter that can be autonomously set by the base station 908. In another example, the base station can determine C1 first and can compare it to a threshold (also autonomously set). If larger than the threshold, the base station 908 need not request the CSI Type II report or compare C2 to a threshold or the difference of the capacities to the threshold D. Otherwise, the second capacity C2 can be determined and used in the selection. In yet another example, the base station can determine the SNR and based on a threshold (e.g., 5 dB as in FIG. 5), can select the CSI type configuration (e.g., the CSI Type I configuration is selected if the SNR is smaller than the threshold, otherwise the CSI Type II configuration is selected). The SNR can be determined from the channel estimation generated by the UE and reported in either or both the CSI Type I report or the CSI Type II report.

In an example, the performance can be estimated based on the Doppler metric 944 of the UE. In this method, the base station 908 determines the UE's Doppler metric 944, which can be an indication of the UE's speed. If the Doppler metric 944 is less than a predefined threshold (also preset or indicated by the network), then the CSI Type II configuration is selected because it is known to perform better at lower speeds. Otherwise, the CSI Type I configuration is deemed better for the current channel conditions. The Doppler metric 944 can be computed as the rate of change to the channel estimation. Particularly, the base station 908 can monitor the channel estimation (indicated in CSI reports) over time to determine the rate of change and can set this rate as the Doppler metric 944. Additionally, or alternatively to computing the Doppler metric 944, the base station 908 can determine the UE's speed (e.g., by monitoring change to the UE's location over time) and compare the speed to a threshold. Here also, a low speed (e.g., one below the threshold) results in selecting the CSI Type II configuration. Otherwise, the CSI Type I configuration is selected.

In an example, the performance can be estimated based on the reference signal measurement 946. The reference signal measurement 946 can be RSRP determined by the UE from the CSI-RS from SSB. The RSRP can be reported to the base station 908. Alternatively, channel reciprocity is assumed. In this case, the UE sends an uplink reference signal that the base station 908 measures to determine an RSRP. In both cases, if the RSRP is above a predefined threshold (also preset or indicated by the network), suggesting proximity to the cell center where signal strength is stronger, the CSI Type II configuration can be selected. Conversely, the CSI Type I configuration can be preferred if the UE is closer to the cell edge or in the middle range (e.g., the RSRP being smaller than the threshold), where signal strength is weaker.

In an example, the performance can be estimated based on the position 948. The position 948 can be the relative position (e.g., possibly the relative distance) between the base station 908 and a base station (or a reference point of a serving cell). As illustrated in FIG. 5, the network can benefit from the CSI Type II configuration 912 primarily in conditions of high Signal-to-Noise Ratio (SNR), whereas the CSI Type I configuration 911 is sufficient for achieving beamforming gains at lower SNR levels. The base station 908 can estimate its position relative to the base station (e.g., through positioning technologies that involves the base station or other positioning systems such as a global position system (GPS)) and recommend the CSI Type I configuration 911 if the base station 908 is far from the base station, or the CSI Type II configuration 912 if the base station 908 is closer.

In an example, the performance can be estimated based on the UE resource limitation 950. This limitation 950 can relate to one or more components of the UE that may impact the performance, such as the battery level or processing loads (e.g., usage of baseband processors). The limitation 950 can also relate to the carrier and carrier aggregation configuration that are assigned by the network and/or to other constraints related to resource allocation and/or data reception and/or data transmission. Generally, the larger or more severe the limitation 950 is, the more likely that the base station 908 selects using the CSI Type I configuration. In a simple illustration, if the UE's 904 battery level is below a threshold (e.g., ten percent), the base station 908 selects the CSI Type I configuration. Otherwise, the CSI Type II configuration is recommended.

In an example, the performance can be estimated based on the network load 952. One more criterion for determining whether CSI Type I or CSI Type II to use can based on the load of the carrier. Generally, when the load of the network is high, MU-MIMO can provide significant gains over SU-MIMO. For MU-MIMO pairing of the UEs, CSI Type II feedback provides more information about the channel than Type I CSI. Hence, say that the network load 952 is greater than a predefined threshold (e.g., fifty percent), then the CSI Type II configuration is selected. Otherwise, the CSI Type I confirmation is selected. The base station 908 can monitor the number of RRC_CONNECTED UEs using a carrier and set this number as the network load 952.

In an example, the performance can be estimated based on the CSI report. For instance, CSI Type I report is requested first. Channel estimation, SNR, or throughput capacity can be determined based on this report and compared to one or more thresholds. Depending on the outcome of the comparison, the base station 908 can determine that the CSI Type I report is sufficient and request the use of the CSI Type I configuration for subsequent CSI reporting. Otherwise, the base station 908 can request a CSI Type II report.

Once the base station 908 determines the type of the CSI it prefers (e.g., the selected CSI configuration), the base station 908 requests the UE's CSI reporting to use the selected CSI configuration (e.g., the CSI Type I configuration, the CSI Type II configuration, or the hybrid CSI configuration). The request can be part of DCI instructing the UE for aperiodic CSI reporting. In the case of the hybrid CSI configuration, the CSI report can indicate whether the CSI Type I configuration or the CSI Type II configuration was used. For example, one or more bits of the CSI report can set to have bit values indicating the used CSI configuration.

Various advantages can result from using the approach of FIG. 9. For example, efficient use of uplink resources for reporting CSI at the same time without compromising on the performance of the system can be achieved. Furthermore, the battery life of a UE can be improved by optimizing the UE's component usage because the UE can get the same performance as that of eType-II standalone system by using a CSI Type I configuration in certain situations.

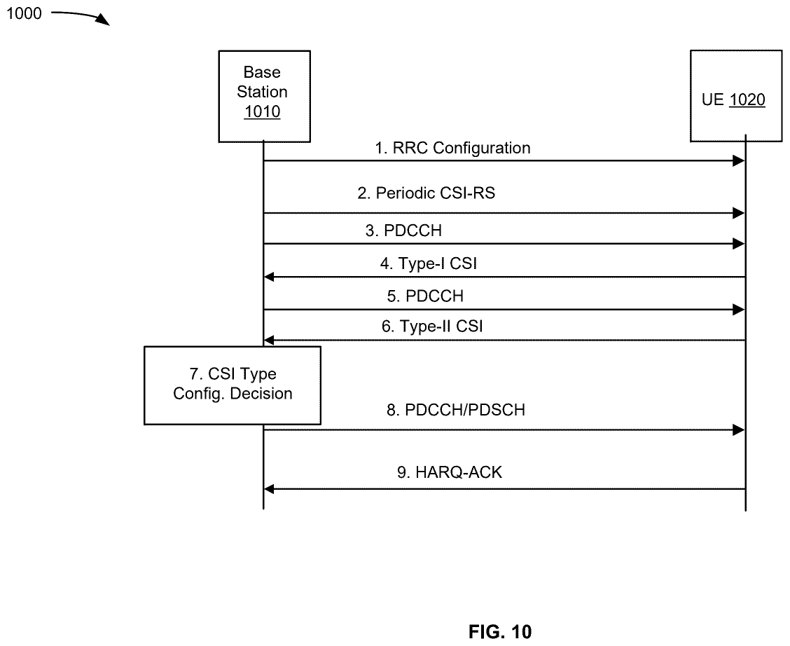

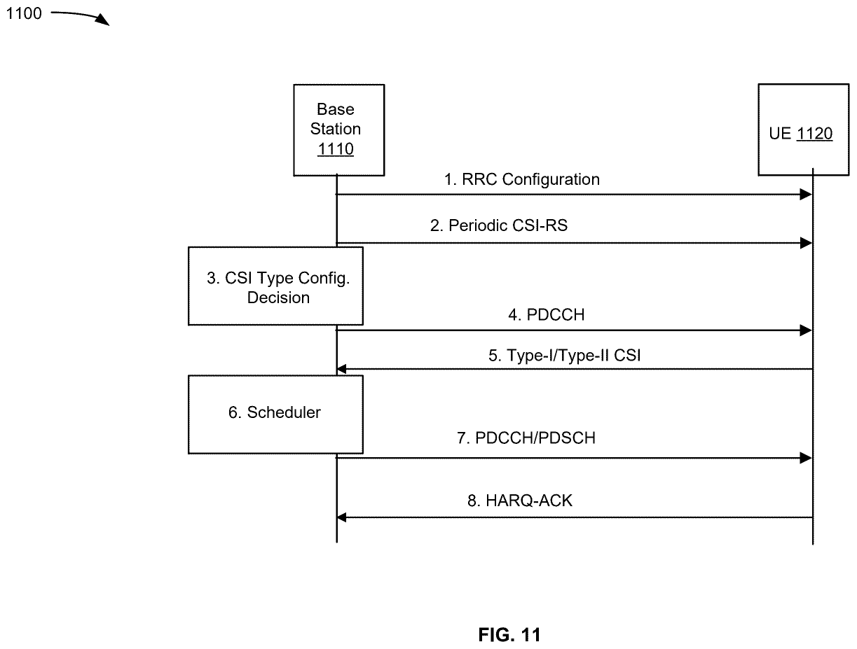

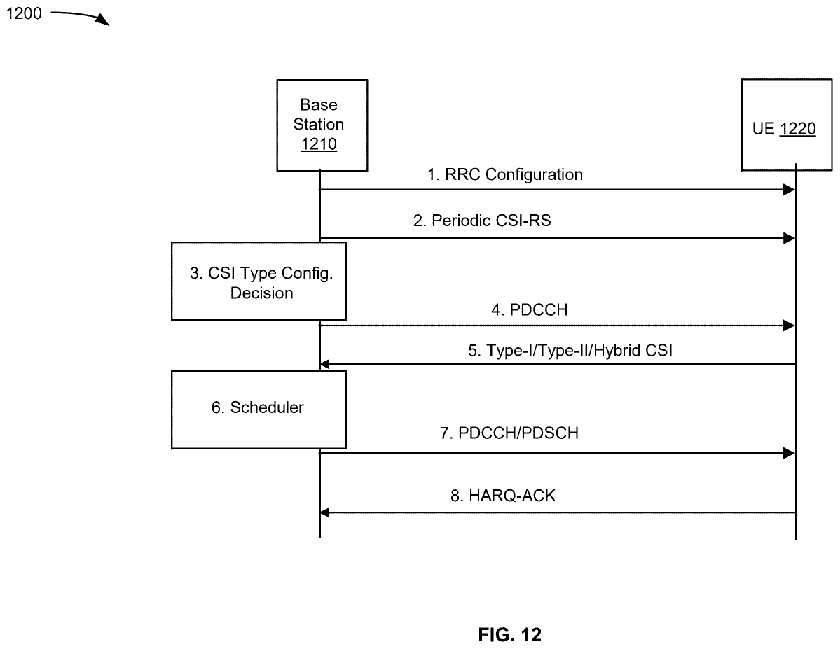

Various approaches are possible to implement the base station-based determination of a CSI type for CSI reporting. One approach relies on receiving CSI reports from the UE and is further described in FIG. 10. Another approach avoids the need for CSI reports for the decision and is described in FIG. 11. Yet another approach relies on the hybrid CSI configuration and is described in FIG. 12.

FIG. 10 illustrates an example of a sequence diagram 1000 that involves a base station-based determination of a CSI type for CSI reporting, in accordance with some embodiments. Steps of the sequence diagram 1000 can be executed by a base station 1010 (an example of the base station 908) and a UE 1020 (an example of the UE 104). The CSI can be computed based on a CSI Type I configuration or a CSI Type II configuration.

As illustrated, in a first step of the sequence diagram 1000, the base station 1010 sends an RRC configuration to the UE 1020 (e.g., configuration information via RRC signaling). The RRC configuration corresponds to, among other things, the base station 1010 indicating a periodic CSI-RS resource configuration and at least two aperiodic CSI reporting configurations, where one is for CSI reporting using CSI Type I and the other one is for CSI reporting using CSI Type II (possibly CSI eType II). In a second step, based on the periodic CSI-RS resource configuration, the base station 1010 periodically sends CSI-RS to the UE 1020 (e.g., in the configured resources). As such, the base station 1010 the UE 1020 with multiple CSI reporting configurations, ensuring that at least one is set up for Type I CSI and another for Type II CSI reporting. Additionally, the base station 1010 configures the CSI-RS resources using RRC signaling and ensures that the CSI-RS is transmitted periodically. Once the reporting configurations and resources are established via RRC signaling, the base station 1010 periodically transmits the CSI-RS.

To determine the optimal CSI configuration, the base station 1010 requests the CSI aperiodically, initially using the Type I CSI configuration and subsequently using the Type II CSI configuration. The third step through the fifth step of the sequence diagram 1000 shows this exchange. Particularly, PDCCH is used to request the aperiodic CSI Type I report (the third step) that is then sent in an uplink channel (e.g., PUCCH, shown in the fourth step). Subsequently, PDCCH is used again to request the aperiodic CSI Type II report (the fifth step) that is then sent in an uplink channel (e.g., PUCCH, shown in the sixth step). The time difference between the two requests can be within a predefined time duration (e.g., within two slots). The base station's 1010 requests for CSI can be made through a specific field in the downlink control channel, carried by the PDCCH (e.g., specific DCI fields).

In a seventh step of the sequence diagram 100, after receiving the individual CSI reports for each CSI configuration, the base station 1010 decides whether to schedule the UE with Type I CSI or Type II CSI. The decision can use one or more of the CSI selection parameters 940 of FIG. 9.

The scheduling information is then communicated through the PDCCH and the actual data transmission follows (shown in the eight step). In a ninth step, the UE 1020 can send hybrid automatic repeat request acknowledgement (HARQ-ACK) in response to the data transmissions of the base station 1010.

FIG. 11 illustrates another example of a sequence diagram 1100 that involves a base station-based determination of a CSI type for CSI reporting, in accordance with some embodiments. Here and unlike the sequence diagram 1000 of FIG. 10, no CSI report is needed for this determination. Steps of the sequence diagram 1100 can be executed by a base station 1110 (an example of the base station 908) and a UE 1120 (an example of the UE 104). The CSI can be computed based on a CSI Type I configuration or a CSI Type II configuration.

As illustrated, in a first step of the sequence diagram 1100, the base station 1110 sends an RRC configuration to the UE 1120 (e.g., configuration information via RRC signaling). The RRC configuration corresponds to, among other things, the base station 1110 indicating a periodic CSI-RS resource configuration and at least two aperiodic CSI reporting configurations, where one is for CSI reporting using CSI Type I and the other one is for CSI reporting using CSI Type II (possibly CSI eType II). In a second step, based on the periodic CSI-RS resource configuration, the base station 1110 periodically sends CSI-RS to the UE 1120 (e.g., in the configured resources). As such, the base station 1110 the UE 1120 with multiple CSI reporting configurations, ensuring that at least one is set up for Type I CSI and another for Type II CSI reporting. Additionally, the base station 1110 configures the CSI-RS resources using RRC signaling and ensures that the CSI-RS is transmitted periodically. Once the reporting configurations and resources are established via RRC signaling, the base station 1110 periodically transmits the CSI-RS.

To determine the optimal CSI configuration, the base station 1110 need not request CSI reports using the CSI Type I configuration or the CSI Type II configuration. Instead, in a third step of the sequence diagram 1100, the base station 1101 determines whether Type I CSI is better for the UE or Type II CSI is better and generates a CSI type configuration decision (e.g., to select the CSI Type I configuration or the CSI Type II configuration). The decision can use one or more of the CSI selection parameters 940 of FIG. 9 (except the parameter that involve the CSI reporting; the usable parameters can include any or a combination of the UE's 1020 Doppler metric, the network load, the RSRP, and/or position). Once the base station 1010 decides which is better, it requests the CSI aperiodically. This can be done by indicating the CSI request in the downlink control channel, carried by the PDCCH (e.g., specific DCI fields; shown in the fourth step of the sequence diagram 1100). After receiving the corresponding CSI from the UE (e.g., the CSI Type I report or the CSI Type II report; shown in the fifth step of the sequence diagram 1100), the base station 1010 decides the scheduling information from the received CSI (shown in the sixth step of the sequence diagram 1100). The scheduling information is then communicated through the PDCCH, and the actual data transmission follows (shown in the seventh step of the sequence diagram 1100). In an eight step, the UE 1120 can send hybrid automatic repeat request acknowledgement (HARQ-ACK) in response to the data transmissions of the base station 1110.

FIG. 12 illustrates yet another example of a sequence diagram that involves a base station-based determination of a CSI type for CSI reporting, in accordance with some embodiments. Similar to the sequence diagram 1100 of FIG. 11, no CSI report is needed for this determination. However, here, a hybrid CSI configuration is also configured and possibly used. Steps of the sequence diagram 1200 can be executed by a base station 1210 (an example of the base station 908) and a UE 1220 (an example of the UE 104). The CSI can be computed based on a CSI Type I configuration or a CSI Type II configuration.

As illustrated, in a first step of the sequence diagram 1200, the base station 1210 sends an RRC configuration to the UE 1220 (e.g., configuration information via RRC signaling). The RRC configuration corresponds to, among other things, the base station 1210 indicating a periodic CSI-RS resource configuration, at least two aperiodic CSI reporting configurations (e.g., one is for CSI reporting using CSI Type I and the other one is for CSI reporting using CSI Type II (possibly CSI eType II)), and a hybrid CSI configuration (e.g., one that enables the UE 1202 to decide between the CSI Type I configuration and the CSI Type II configuration). In a second step, based on the periodic CSI-RS resource configuration, the base station 1210 periodically sends CSI-RS to the UE 1220 (e.g., in the configured resources). As such, the base station 1210 the UE 1220 with multiple CSI reporting configurations, ensuring that at least one is set up for Type I CSI and another for Type II CSI reporting. Further, the hybrid CSI configuration set up for a fallback in case the base station 1210 is incapable of deciding between the CSI Type I reporting and the CSI Type II reporting. Additionally, the base station 1210 configures the CSI-RS resources using RRC signaling and ensures that the CSI-RS is transmitted periodically. Once the reporting configurations and resources are established via RRC signaling, the base station 1210 periodically transmits the CSI-RS.

To determine the optimal CSI configuration, the base station 1210 need not request CSI reports using the CSI Type I configuration or the CSI Type II configuration. Instead, in a third step of the sequence diagram 1200, the base station 1201 determines whether Type I CSI is better for the UE or Type II CSI is better and generates a CSI type configuration decision (e.g., to select the CSI Type I configuration or the CSI Type II configuration). The decision can use one or more of the CSI selection parameters 940 of FIG. 9 (except the parameter that involve the CSI reporting; the usable parameters can include any or a combination of the UE's 1020 Doppler metric, the achievable capacity, the network load, the RSRP, and/or position). Once the base station 1010 decides which of the CSI Type I configuration or CSI Type II configuration is better, it requests the CSI aperiodically. If the base station 1010 unsure whether Type I CSI reporting is better or Type II CSI reporting is better, then the base station 1010 can choose hybrid CSI configuration. If this configuration is selected, CSI can also be requested choose aperiodically. The aperiodic CSI request can be done by indicating the CSI request in the downlink control channel, carried by the PDCCH (e.g., specific DCI fields; shown in the fourth step of the sequence diagram 1200). After receiving the corresponding CSI from the UE (e.g., the CSI Type I report or the CSI Type II report; shown in the fifth step of the sequence diagram 1200), the base station 1010 decides the scheduling information from the received CSI (shown in the sixth step of the sequence diagram 1200). The scheduling information is then communicated through the PDCCH, and the actual data transmission follows (shown in the seventh step of the sequence diagram 1200). In an eight step, the UE 1220 can send hybrid automatic repeat request acknowledgement (HARQ-ACK) in response to the data transmissions of the base station 1210.

Note that in the fifth step, the CSI report is either a CSI Type I report or a CSI Type II report. In case the base station 1010 requested the UE 1020 to use the hybrid CSI configuration, the base station 1010 needs to determine whether the CSI report is a CSI Type I report or a CSI Type II report. To do so, a new field in the CSI report be added. For example, the CSI can start with a single bit that indicates the type of the CSI. In an illustration, “[0, CSI]” corresponds to the CSI Type I configuration and the corresponding CSI, whereas “[1, CSI]” represents the CSI Type II configuration and the corresponding CSI.

Referring to FIGS. 1-12, generating a CSI report can include computing RI and PMI. The computation can involve searching many different codebooks. The search and, thus, the computation using a CSI Type II configuration (including a CSI eType II configuration) is more complex than those using a CSI Type I configuration. Described herein next are approaches for reducing the complexity of generating the CSI report using a CSI Type II configuration by relying on information (e.g., an RI) determined using the CSI Type I configuration.

Referring to a 5G NR system, the network can request CSI periodically or aperiodically. With periodic and aperiodic CSI reporting the UE may need to compute RI in too many times. Finding PMI and RI with a greater number of CSI-RS ports can be highly complex necessitating an exhaustive search of over codebook elements. It involves many computations and may be difficult to implement with the increase in the number of transmit antennas with multiple component carriers.

As described herein above, the network may also configure the UE with multiple report configurations, where one report can request CSI Type I and another report can request CSI Type II (possibly including CSI eType II). With multiple report configurations and multiple carriers with massive number of CSI-RS ports (e.g., thirty-two ports) computing the CSI periodically or aperidocically impacts the UE's battery life or its power consumption and consumes more memory and processing units at the UE. The reason is that the increase of number of CSI-RS ports results in growth to the codebook size. Hence with the available hardware and/or software resources finding, within a limited time budget, rank information and the corresponding precoding matrix computation is highly complex. The approach described herein next can be beneficial to large, massive MIMO systems for achieving the beamforming gains when the network configures multiple CSI reporting configurations.

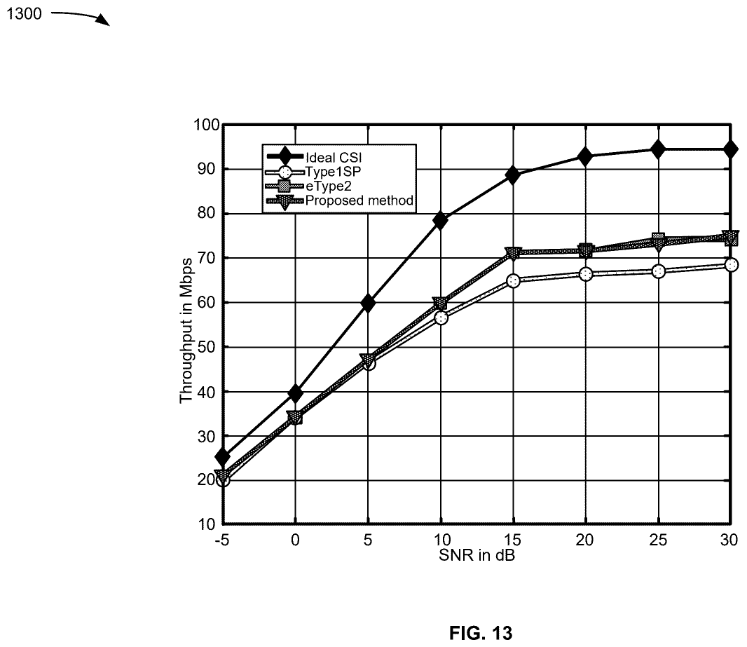

FIG. 13 illustrates an example of a plot 1300 showing link throughputs based on different CSI computations, in accordance with some embodiments. The vertical line of the plot 1300 correspond to the throughput in Mbps (e.g., a link throughput). The horizontal line of the plot 1300 corresponds to the SNR in dB. The plot 1300 shows the throughput as a function of the SNR in four CSI reporting use cases: for using ideal CSI (labeled with “ideal CSI”), for using CSI Type I (labeled with “Type1SP”), for using CSI eType II (labeled with “eType2”), and for using a proposed method further described in the next figures (labeled as “proposed method”). Generally, the proposed method includes using information from a CSI Type I report to generate a CSI Type II report.

The plot 1300 is generated using a simulation, where the UE is configured with thirty-two port CSI-RS and requesting Type I CSI report only and the other case with eType II CSI report only. For the simulation of the proposed method, an RI “R1” was determined using the CSI Type I configuration. A rank hypothesis of “[R1, R1+1]” was used for the CSI computation using the CSI Type II configuration. In other words, rather than performing a CSI Type computation using all possible ranks, the RI “R2” for the CSI Type II computation was constrained to “R1” and to the next adjacent RI to “R1” (e.g., the RI that is equal to “R1+1.” By not using all RIs (e.g., possible four RIs in the case of a CSI eType II configuration), the computation of the CSI Type II report was reduced by fifty percent (e.g., because only two RIs were used: “R1” and “R1+1”). The remaining simulation assumptions are shown in Table 3.

It can be observed that the performance of the proposed method is almost equal to the CSI eType-II configuration with all the rank hypothesis (e.g., all four RIs: “[1 2 3 4]”). Hence, the proposed method does not incur any loss, while at the same time significantly reduces the possible rank and precoder combinations in finding the CSI.

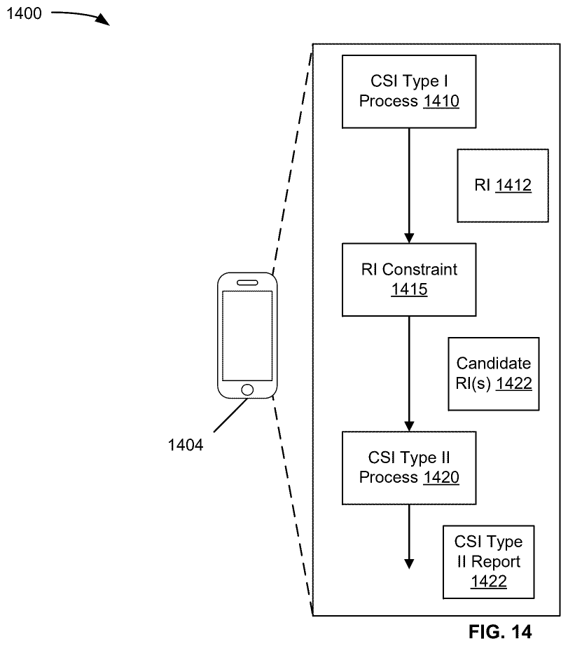

FIG. 14 illustrates an example of a UE 1404 configured to support different CSI computations, in accordance with some embodiments. The UE 1404 is an example of the UE 104 of FIG. 1. As illustrated, the UE can implement (in hardware and/or software) a CSI Type I process 1410 and a CSI Type II process 1420. The CSI Type I process 1410 is used to generate a CSI Type I report by using a CSI Type I configuration (e.g., the CSI Type I configuration 611 of FIG. 6). The CSI I Type I process 1410 is used to generate a CSI Type I report by using a CSI Type I configuration (e.g., the CSI Type I configuration 611 of FIG. 6). The CSI I Type II process 1420 is used to generate a CSI Type II report 1422 by using a CSI Type II configuration (e.g., the CSI Type II configuration 612 of FIG. 6) and at least some of the information available as an output of the CSI Type I process 1410. Doing so allows the CSI Type II process 1420 to omit some precoder entries without compromising the performance of the system. In one example, the information can include an RI 1412 that is outputte by the CSI Type I process 1410.

The RI 1412 can be included in a CSI Type I report output by the CSI Type I process 1410. However, it sufficient for the CSI Type I process 1410 to only output the RI 1412 without outputting or computing one or more other features of a CSI Type I report. For example, if the UE 1404 selects or is requested to use the CSI Type II configuration, it may be sufficient for the CSI Type I process 1410 to output the RI 1412 without one or more other features of a CSI Type I report. However, if the UE 1404 needs to compute both types of CSI reports, the CSI Type I process 1410 can output a CSI Type I report that includes the RI 1412.

To use the RI 1412 in the CSI Type II process 1420, an RI constraint 1415 is applied as an input to the CSI Type II process 1420. Particularly, the CSI Type II configuration can include a set of RIs to be used in a codebook search: (e.g., “{RIᵢ},” where “i” is a positive integer that varies between “1” and “k,” and where “k” is predefined or configured by the network such as being “2” in the case of a Release 15 CSI Type II configuration and “4” in the case of a Release 16 CSI eType II configuration). The constraint RI constraint 1415 limits the set to a subset.

In one example, the subset includes the RI 1412 and the next adjacent RI. Particularly, say the RI 1412 has a first value (e.g., “2”), then the next adjacent RI is the first value incremented by one (e.g., “3”). Denote the first value as “R1”. The subset in this example is “{R1, R1+1}.”

In another example, the subset includes the RI 1412 and the previous adjacent RI (e.g., the RI that is adjacent to and smaller than the RI 1412). Particularly, say the RI 1412 has a first value (e.g., “2”), then the previous adjacent RI is the first value decremented by one (e.g., “1”). Denote the first value as “R1”. The subset in this example is “{R1−1, R1}.”

In yet another example, the subset includes the RI 1412, the previous adjacent RI, and the next adjacent RI. Particularly, say the RI 1412 has a first value (e.g., “2”), then the previous adjacent RI is the first value decremented by one (e.g., “1”) and the next adjacent RI is the first value incremented by one (e.g., “3”). Denote the first value as “R1”. The subset in this example is “{R1−1, R1, R1+1}.”

In a further example, the subset includes only the RI 1412. Particularly, denote the first value as “R1”. The subset in this example is “{R1}.” This can be the case when “R1” is already the largest value of set “{RIᵢ}” and no next adjacent RI exist. This can also be the case when “R1” is already the smallest value of set “{RIᵢ},” and no previous adjacent RI exist. Yet, this can be the case when the UE determines that the channel is associated with a low SNR (e.g., less than a predefined threshold, such as 5 dB where the CSI Type I report can result in significantly similar throughput capacity as the CSI Type II report as in FIG. 13).

Other examples are possible, whereby the RI 1412 is used as part of the RI constraint 1415. For example, the subset can be defined to include the previous adjacent RI and/or the next adjacent RI but not the RI 1412. Generally, the RI constraint 1415 limits the subset to a range of RIs, where this range is based on the RI 1412.

Once the RI constraint 1415 is applied per the above, candidate RI(s) 1422 are determined. These candidate RI(s) 1422 are the RI(s) that belong (belongs) to the subset. The candidate RI(s) 1422 is (are) input to the CSI Type II process 1420 that then limits its codebook search to the candidate RI(s) 1422 rather than all RIs of the set “{RIᵢ}.”

The use of the information from the CSI Type I process 1410 in the CSI Type II process 1420 can reduce the complexity. Particularly, determining the best precoder in both Type I CSI and Type II CSI involves computing the best rank information and finding the precoder within that rank, which can be complex. Generally, the rank information is computed over the whole bandwidth part. As such, the rank information does not change so often, thereby allowing to take advantage of the rank information computation by the CSI Type I process 1410 in the computation of the CSI Type II process 1420.

If the network configures say multiple CSI reporting configurations and say one report configuration is configured with Type I CSI and the other with eType II CSI, then the network can use some information (e.g., rank information) in minimizing the CSI computation for the eType II CSI. Note that the computing the rank information using Type I CSI is relatively simpler than that for eType II CSI as the number of codebook entries is typically less. In eType II CSI, the conventional rank computation involves choosing the best combination of the beams belonging to all the possible rank combinations. As shown in the plot 1300, the rank computed using eType II CSI using conventional approach (with all the possible combinations) relates to the rank computed using Type I CSI (this is shown in polot 1300 where the link throughput resulting from using the eType II CSI is substantially the same as the one resulting using the proposed method).

As described in FIG. 14, say “R1” is the rank computed using a CSI Type I configuration, and “R2” is the rank computed using a CSI eTpe II configuration, then “R2” typically belongs to the subset formed by “R1”, “R1-1,” and/or “R1+1.” Hence say if the “R1=3,” then for eType II CSI, the network can filter out the precoder combinations belonging to “rank=1 and 2” and choose only combinations belonging to “rank=3 and 4,” thereby reducing the complexity by fifty percent.

The approach described in FIG. 14 provides various advantages. For example, the percentage degradation with respect to the full search is almost zero, while the complexity can be reduced significantly. This can improve the battery life of a UE. Further, UE hardware resources (e.g. memory and processing units) can be partly relieved to allow the UE to efficiently execute additional procedures (e.g. inter-radio access technology (RAT) measurements) in parallel to CSI estimation or supporting more simultaneous component carrier (e.g., instead of three, four or five component carriers can be supported).

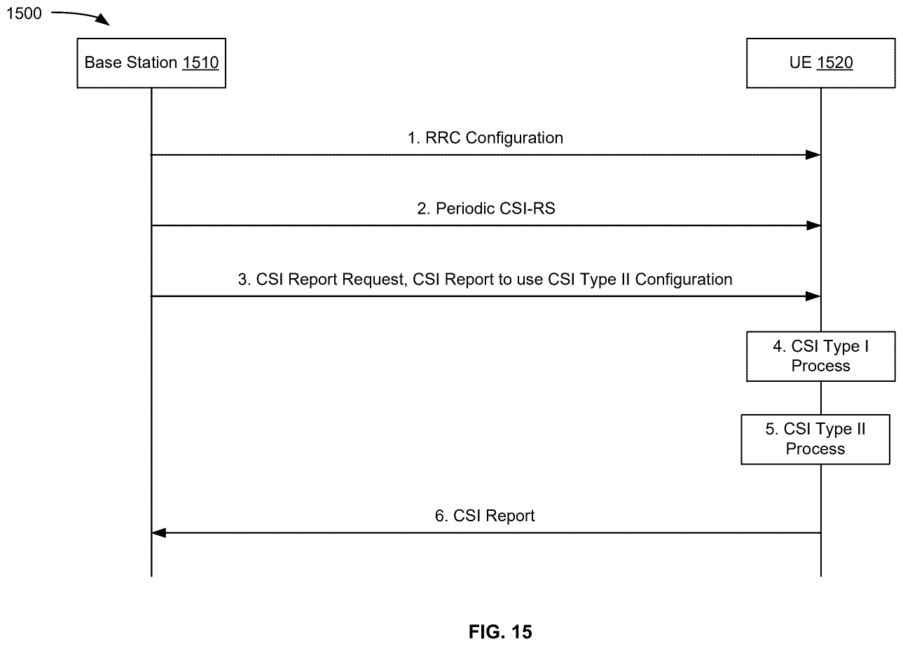

FIG. 15 illustrates an example of a sequence diagram 1500 that involves CSI computations, in accordance with some embodiments. Steps of the sequence diagram 1500 can be executed by a base station 1510 (an example of the base station 108) and a UE 1520 (an example of the UE 1404). The UE 1520 can compute rank information using a CSI Type I configuration and use this information for constraining a Type II rank hypothesis. The Type II rank hypothesis is then used to compute Type II CSI (possibly including eType II CSI), which also relies on a CSI Type II configuration (possible a CSI eType II configuration).

As illustrated, in a first step of the sequence diagram 1200, the base station 1210 sends an RRC configuration to the UE 1220 (e.g., configuration information via RRC signaling). The RRC configuration corresponds to, among other things, the base station 1210 indicating a periodic CSI-RS resource configuration and at least two CSI reporting configurations (e.g., one is for CSI reporting using CSI Type I and the other one is for CSI reporting using CSI Type II (possibly CSI eType II)). The CSI reporting can be periodic or aperiodic. In a second step, based on the periodic CSI-RS resource configuration, the base station 1510 periodically sends CSI-RS to the UE 1520 (e.g., in the configured resources). In a third step (used for aperiodic CSI reporting), the base station 1510 can sent a CSI request (e.g., indicated by DCI) to the UE 1520, requesting a CSI report that uses the CSI Type II configuration. Alternatively, the UE 1520 cane configured or signaled to periodically report Type II CSI.

In a fourth step of the sequence diagram 1500, the UE 1520 performs a CSI Type I process (an example of the CSI Type I process 1410 of FIG. 14). Information included in the output of this process can be used in a fifth step of the sequence diagram 1500, whereby the UE 1520 performs a CSI Type II process (an example of the CSI Type II process 1420 of FIG. 14) using this information. In a sixth step, the UE 1520 sends the CSI report (e.g., a CSI Type II report) in an uplink channel (e.g. PUCCH or PUSCH).

In an example, the fourth step can involve the UE 1520 estimating the channel and the noise plus interference covariance from the configured CSI-RS resources. With all the possible combinations of the Type-I codebook, the UE 1520 can compute the best possible rank information. For instance, the UE 1520 can choose the best rank which can maximizes the capacity (e.g., throughput capacity). Say this rank is “R1.”

In an example, the fifth step can involve the UE 1520 input the rank information computed using the CSI Type I configuration to the CSI Type II process. Here, the CSI Type II process can choose only the ranks belonging to the rank information from the CSI Type I process and an adjacent rank (e.g., “{R1, R1+1}”) in the TypeII rank information search. Next, the CSI Type II process can compute the best precoders belonging to the rank from the CSI Type I process and the adjacent rank (e.g., “{R1, R1+1}”) in Type-II PMI reporting based on the combinations which can provide best capacity.

In FIG. 15 and elsewhere in the present disclosure, a first RI determined based on a CSI Type I process can be used for determining a second RI by a second CSI Type II process. However, the embodiments of the present disclosure are not limited as such. For instance, the opposite use can be additionally or alternatively implemented. In particular, a third RI determined based on the CSI Type II process can be used for determining a fourth RI by the CSI Type I process. That is to say, the third RI can be output upon an executing of the CSI Type II process. This third RI can be included in an input to the CSI Type I process or used to constrain the subset of candidate RIs in the input. Accordingly, based on the third RI, the CSI Type I process can output the fourth RI.

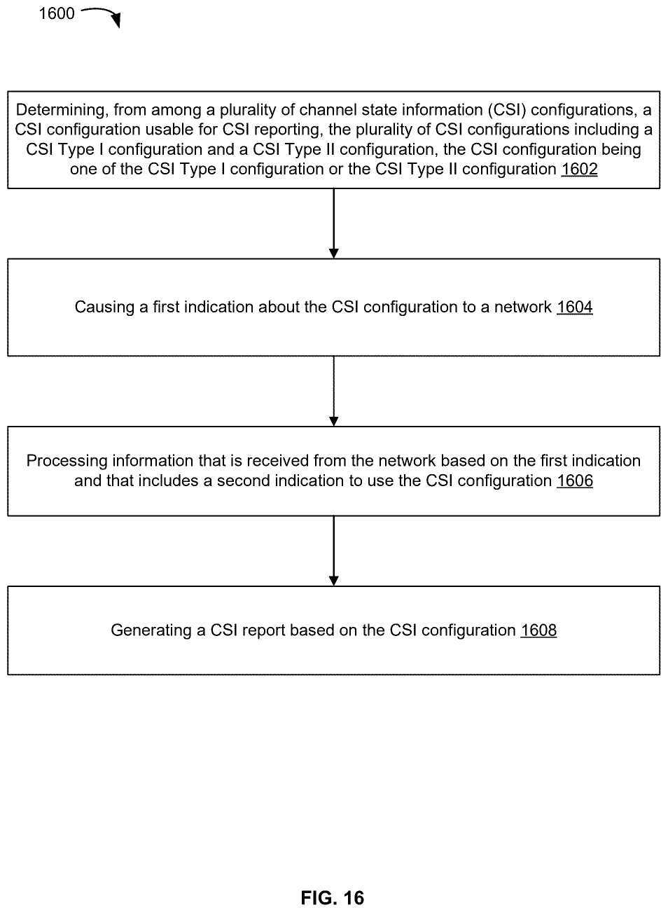

FIG. 16 illustrates an example of an operational flow/algorithmic structure 1600 implemented by a UE (or an apparatus of the UE, where the apparatus includes processing circuitry) for a UE-based CSI type determination, in accordance with some embodiments. The UE can be any of the UEs described herein. In some embodiments, the operational flow/algorithmic structure 1600 may be implemented by executing instructions stored in a tangible, non-transitory, computer-readable storage medium, such as a memory of the UE. While the operational flow/algorithmic structure 1600 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1600 includes at 1602, determining, from among a plurality of channel state information (CSI) configurations, a CSI configuration usable for CSI reporting, the plurality of CSI configurations including a CSI Type I configuration and a CSI Type II configuration, the CSI configuration being one of the CSI Type I configuration or the CSI Type II configuration. For instance, the CSI configuration is selected from the CSI Type I configuration and the CSI Type II configuration based on the CSI selection parameter(s) 640 of FIG. 6.

In an example, the operational flow/algorithmic structure 1600 includes at 1604, causing a first indication about the CSI configuration to a network. For instance, the indication corresponds to a recommendation to use the CSI configuration and is sent to a base station in an uplink channel.

In an example, the operational flow/algorithmic structure 1600 includes at 1606, processing information that is received from the network based on the first indication and that includes a second indication to use the CSI configuration. For instance, DCI is received from the base station, where a DCI field indicates that the CSI configuration is to be used. The DCI can also request aperiodic CSI reporting.

In an example, the operational flow/algorithmic structure 1600 includes at 1608, generating a CSI report based on the CSI configuration. For instance, if the CSI Type I configuration is indicated, the CSI Type I process 1410 of FIG. 14 is used. If the CSI Type II configuration is indicated, the CSI Type II process 1420 of FIG. 14 is used. The CSI report can be sent to the base station.

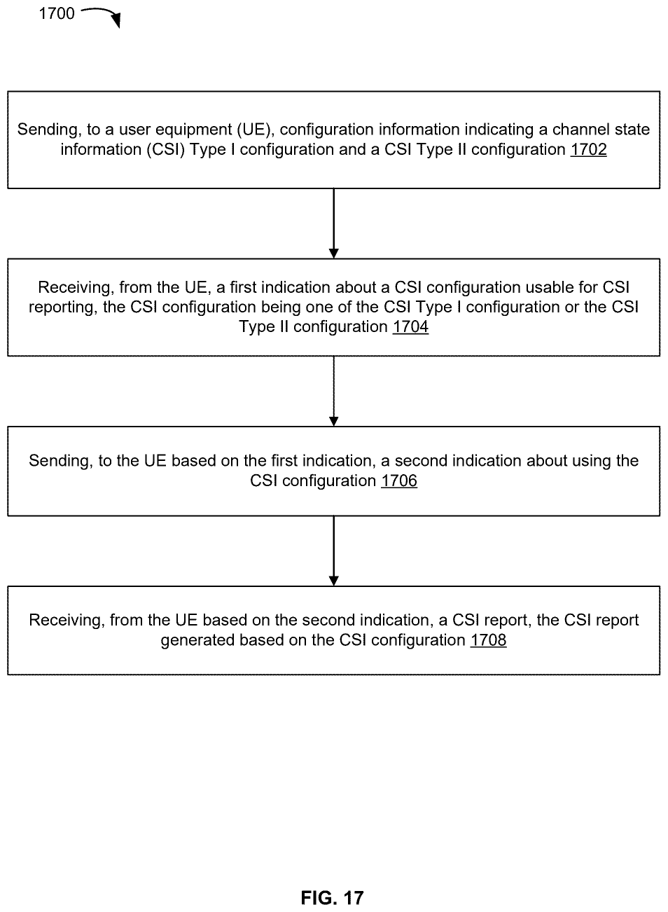

FIG. 17 illustrates an example of an operational flow/algorithmic structure 1700 implemented by a base station (or an apparatus of the base station, where the apparatus includes processing circuitry) for a UE-based CSI type determination, in accordance with some embodiments. The base station can be any of the base stations described herein. In some embodiments, the operational flow/algorithmic structure 1700 may be implemented by executing instructions stored in a tangible, non-transitory, computer-readable storage medium, such as a memory of the base station. While the operational flow/algorithmic structure 1700 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1700 includes at 1702, sending, to a user equipment (UE), configuration information indicating a channel state information (CSI) Type I configuration and a CSI Type II configuration. For instance, the configuration information can be sent via RRC signaling.

In an example, the operational flow/algorithmic structure 1700 includes at 1704, receiving, from the UE, a first indication about a CSI configuration usable for CSI reporting, the CSI configuration being one of the CSI Type I configuration or the CSI Type II configuration. For instance, the first indication corresponds to a recommendation generated by the UE based on the CSI selection parameter(s) 640 of FIG. 6. The recommendation can be received in an uplink channel.

In an example, the operational flow/algorithmic structure 1700 includes at 1706, sending, to the UE based on the first indication, a second indication about using the CSI configuration. For instance, the base station can decide whether to proceed with using the recommended CSI configuration or override the recommendation based on a set of CSI selection parameters (including the CSI selection parameter(s) 940 of FIG. 9). The second indication can correspond to the decision and can be sent in DCI. The DCI can also request aperiodic CSI reporting.

In an example, the operational flow/algorithmic structure 1700 includes at 1708, receiving, from the UE based on the second indication, a CSI report, the CSI report generated based on the CSI configuration. For instance, the UE generates the CSI report by using the CSI Type I process 1410 and/or the CSI Type II process 1420 of FIG. 14 as applicable. The CSI report is received in an uplink channel.

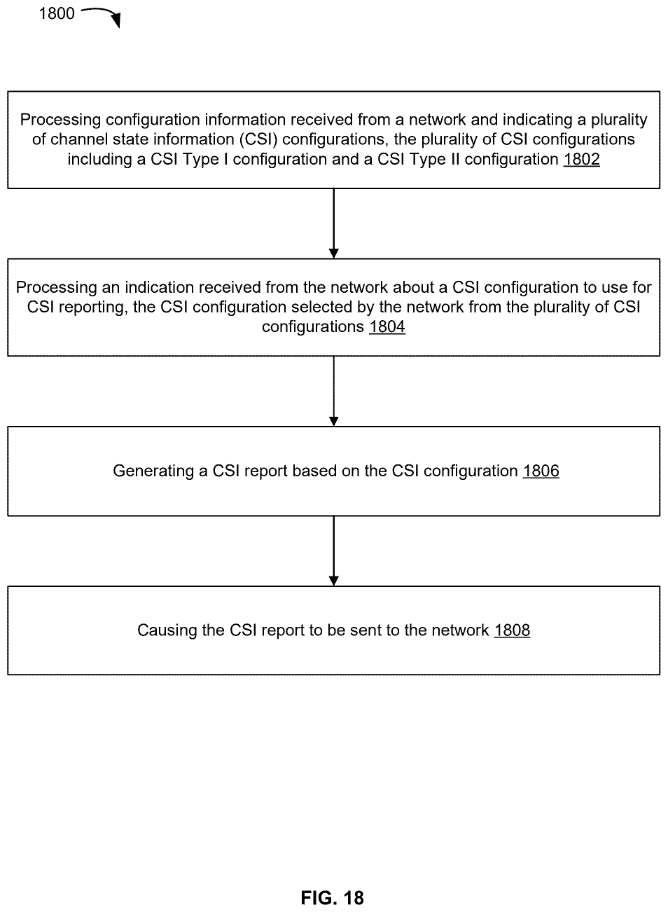

FIG. 18 illustrates an example of an operational flow/algorithmic structure 1800 implemented by a UE (or an apparatus of the UE, where the apparatus includes processing circuitry) for a base station-based CSI type determination, in accordance with some embodiments. The UE can be any of the UEs described herein. In some embodiments, the operational flow/algorithmic structure 1800 may be implemented by executing instructions stored in a tangible, non-transitory, computer-readable storage medium, such as a memory of the UE. While the operational flow/algorithmic structure 1800 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1800 includes at 1802, processing configuration information received from a network and indicating a plurality of channel state information (CSI) configurations, the plurality of CSI configurations including a CSI Type I configuration and a CSI Type II configuration. The configuration information can be received from a base station via RRC signaling.

In an example, the operational flow/algorithmic structure 1800 includes at 1804, processing an indication received from the network about a CSI configuration to use for CSI reporting, the CSI configuration selected by the network from the plurality of CSI configurations. For instance, the indication is received in DCI sent by the base station. The DCI can also request aperiodic CSI reporting that uses the CSI configuration. The base station can decide to use the CSI Type I configuration or the CSI Type II configuration based on CSI selection parameter(s) 940 of FIG. 9. The indication reflects this decision. In a further illustration, the UE can be further configured with a hybrid CSI configuration. If the indication is for the hybrid CSI configuration, the UE can decide whether to use the CSI Type I configuration or the CSI Type II configuration based on CSI selection parameter(s) 640 of FIG. 6.

In an example, the operational flow/algorithmic structure 1800 includes at 1806, generating a CSI report based on the CSI configuration. For instance, if the CSI Type I configuration is indicated or selected, the CSI Type I process 1410 of FIG. 14 is used. If the CSI Type II configuration is indicated or selected, the CSI Type II process 1420 of FIG. 14 is used. The CSI report can be sent to the base station.

In an example, the operational flow/algorithmic structure 1800 includes at 1808, causing the CSI report to be sent to the network. The CSI report can be sent in an uplink channel to the base station.

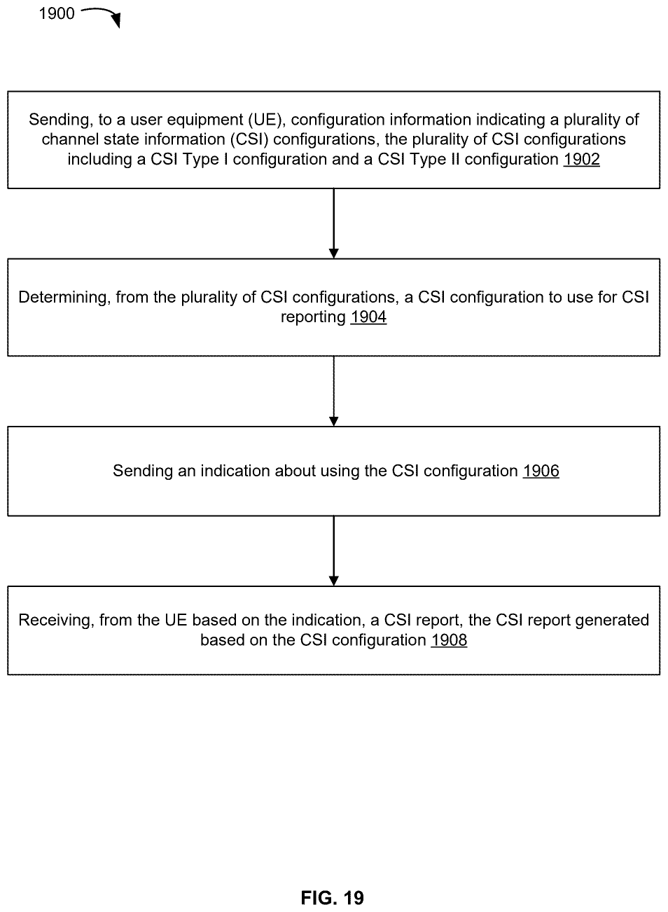

FIG. 19 illustrates an example of an operational flow/algorithmic structure 1900 implemented by a base station (or an apparatus of the base station, where the apparatus includes processing circuitry) for a base station-based CSI type determination, in accordance with some embodiments. The base station can be any of the base stations described herein. In some embodiments, the operational flow/algorithmic structure 1900 may be implemented by executing instructions stored in a tangible, non-transitory, computer-readable storage medium, such as a memory of the base station. While the operational flow/algorithmic structure 1900 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1900 includes at 1902, sending, to a user equipment (UE), configuration information indicating a plurality of channel state information (CSI) configurations, the plurality of CSI configurations including a CSI Type I configuration and a CSI Type II configuration. The CSI configurations can be sent via RRC signaling.

In an example, the operational flow/algorithmic structure 1900 includes at 1904, determining, from the plurality of CSI configurations, a CSI configuration to use for CSI reporting. The base station can decide to use the CSI Type I configuration or the CSI Type II configuration based on CSI selection parameter(s) 940 of FIG. 9. In a further illustration, the UE can be further configured with a hybrid CSI configuration. The base station can decide to use the hybrid CSI configuration based on CSI selection parameter(s) 940 of FIG. 9.

In an example, the operational flow/algorithmic structure 1900 includes at 1906, sending an indication about using the CSI configuration. For instance, the indication can be sent in DCI that also requests aperiodic CSI reporting.

In an example, the operational flow/algorithmic structure 1900 includes at 1908, receiving, from the UE based on the indication, a CSI report, the CSI report generated based on the CSI configuration. For instance, the UE generates the CSI report by using the CSI Type I process 1410 and/or the CSI Type II process 1420 of FIG. 14 as applicable. The CSI report is received in an uplink channel.

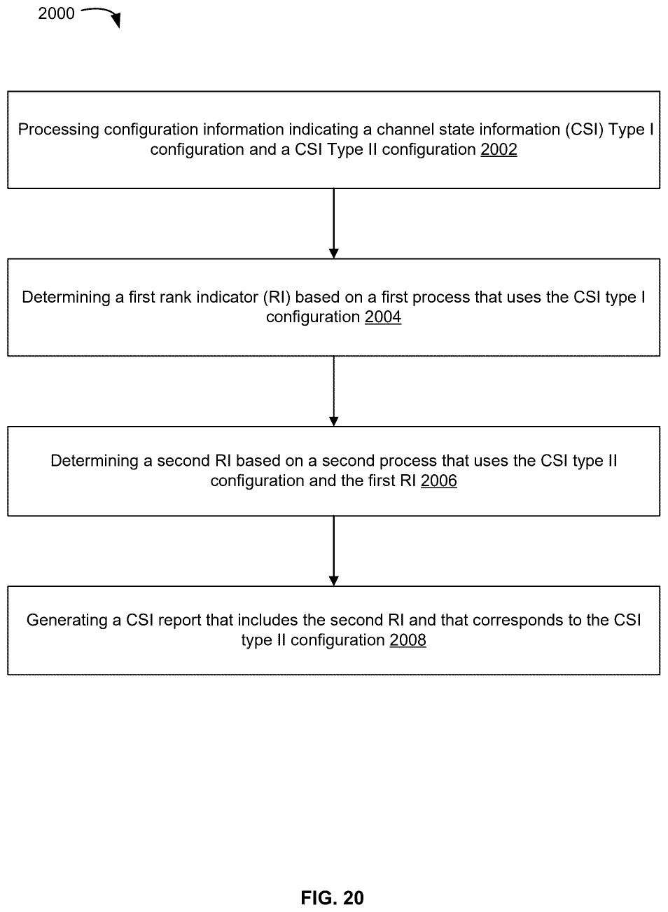

FIG. 20 illustrates an example of an operational flow/algorithmic structure 2000 implemented by a UE or an apparatus of the UE, where the apparatus includes processing circuitry) for UE-based CSI computations, in accordance with some embodiments. The UE can be any of the UEs described herein. In some embodiments, the operational flow/algorithmic structure 2000 may be implemented by executing instructions stored in a tangible, non-transitory, computer-readable storage medium, such as a memory of the UE. While the operational flow/algorithmic structure 2000 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 2000 includes at 2002, processing configuration information indicating a channel state information (CSI) Type I configuration and a CSI Type II configuration. The CSI configurations can be received from a base station via RRC signaling.

In an example, the operational flow/algorithmic structure 2000 includes at 2004, determining a first rank indicator (RI) based on a first process that uses the CSI type I configuration. For instance, the first process can correspond to the CSI Type I process 1410 of FIG. 14. The first process can be performed upon a request for a CSI Type I report or upon a request for a CSI Type II report. An output of the first process can include the first RI.

In an example, the operational flow/algorithmic structure 2000 includes at 2006, determining a second RI based on a second process that uses the CSI type II configuration and the first RI. For instance, the second process can correspond to the CSI Type II process 1420 of FIG. 14. The first RI is used to constraint candidate RIs of the second process to a subset of RIs. The second process can then perform a codebook search using the subset and can determine the second RI from the subset as corresponding to the optimal rank.

In an example, the operational flow/algorithmic structure 2000 includes at 2008, generating a CSI report that includes the second RI and that corresponds to the CSI type II configuration. For instance, the output of the second process includes the CSI report. The CSI report can be sent to the base station.

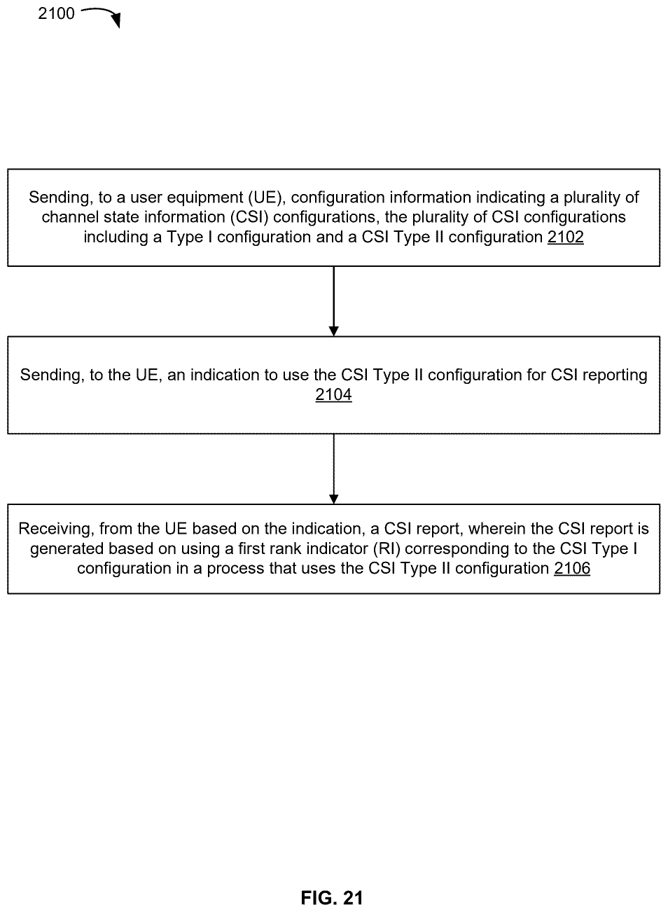

FIG. 21 illustrates an example of an operational flow/algorithmic structure 2100 implemented by a base station (or an apparatus of the base station, where the apparatus includes processing circuitry) for UE-based CSI computations, in accordance with some embodiments. The base station can be any of the base stations described herein. In some embodiments, the operational flow/algorithmic structure 2100 may be implemented by executing instructions stored in a tangible, non-transitory, computer-readable storage medium, such as a memory of the base station. While the operational flow/algorithmic structure 2100 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 2100 includes at 2102, sending, to a user equipment (UE), configuration information indicating a plurality of channel state information (CSI) configurations, the plurality of CSI configurations including a Type I configuration and a CSI Type II configuration. The configuration information can be sent via RRC signaling.

In an example, the operational flow/algorithmic structure 2100 includes at 2104, sending, to the UE, an indication to use the CSI Type II configuration for CSI reporting. For instance, the indication can be sent in DCI. The CSI reporting can be periodic or aperiodic. In the aperiodic use case, the base station can determine that the CSI Type II configuration is to be used per the description herein above.

In an example, the operational flow/algorithmic structure 2100 includes at 2106, receiving, from the UE based on the indication, a CSI report, wherein the CSI report is generated based on using a first rank indicator (RI) corresponding to the CSI Type I configuration in a process that uses the CSI type II configuration. For instance, the UE performs the CSI Type I process 1410 and uses an outputted rank indicator to constrain the search performed by the CSI Type II process 1420. The CSI report is output by the CSI Type II process 1420 and can be received from the UE in an uplink channel.

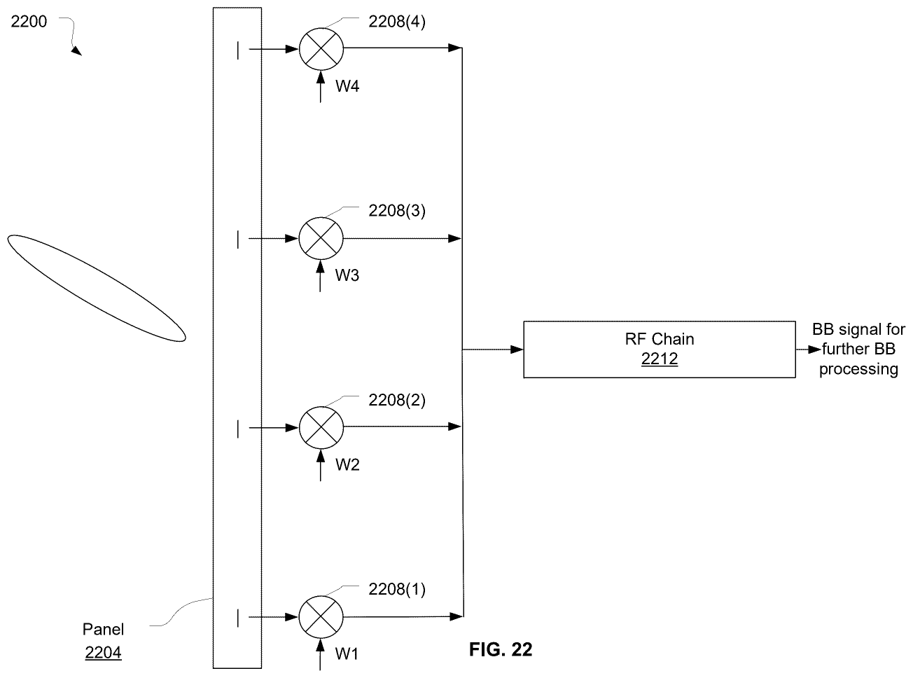

FIG. 22 illustrates receive components 2200 of a UE, such as any of the UE's described herein above, in accordance with some embodiments. The receive components 2200 may include an antenna panel 2204 that includes a number of antenna elements. The panel 2204 is shown with four antenna elements, but other embodiments may include other numbers.

The antenna panel 2204 may be coupled to analog beamforming (BF) components that include a number of phase shifters 2208(1)-2208(4). The phase shifters 2208(1)-2208(4) may be coupled with a radio-frequency (RF) chain 2212. The RF chain 2212 may amplify a receive analog RF signal, down-convert the RF signal to baseband, and convert the analog baseband signal to a digital baseband signal that may be provided to a baseband processor for further processing. In an example, receive components 2200 can include multiple antenna panels 2204 and/or multiple RF chains 2212. An MR can include an antenna panel 2204 and an RF chain 2212. An LP-WUR can include the same antenna panel 2204 or a different antenna panel and a different RF chain 2212.

In various embodiments, control circuitry, which may reside in a baseband processor, may provide BF weights (for example W1-W4), which may represent phase shift values, to the phase shifters 2208(1)-2208(4) to provide a receive beam at the antenna panel 2204. These BF weights may be determined based on the channel-based beamforming.

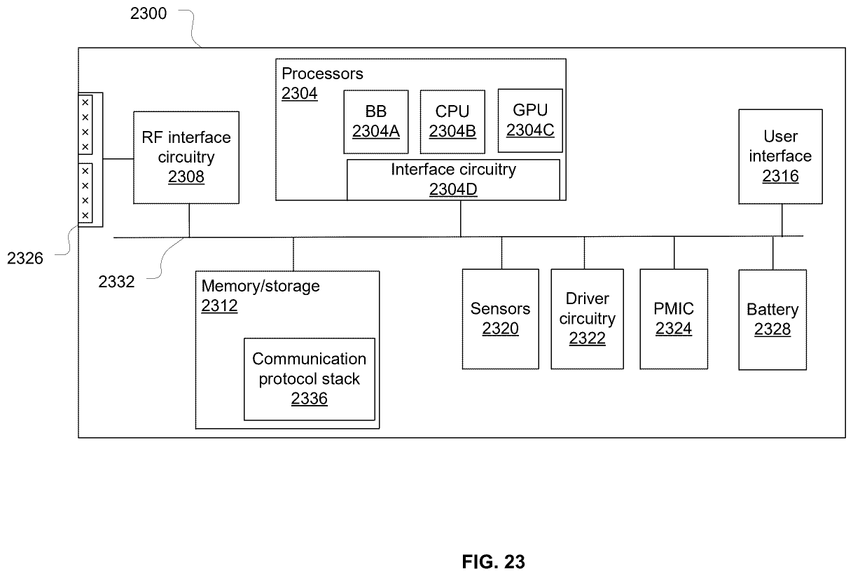

FIG. 23 illustrates a UE 2300, in accordance with some embodiments. The UE 2300 may be similar to and substantially interchangeable with any of the UEs described herein above. Particularly, the UE 2300 can select or recommend a CSI configuration to use from among a plurality of CSI configurations based on a set of factors. Additionally, or alternatively, the UE can use information output by a CSI Type I process in the computation of a Type II CSI by a CSI Type II process.

Similar to that described above with respect to UE 104, the UE 2300 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 2300 may include processors 2304, RF interface circuitry 2308, memory/storage 2312, user interface 2316, sensors 2320, driver circuitry 2322, power management integrated circuit (PMIC) 2324, and battery 2328. The processors 2304, or portions thereof, can represent processing circuitry that can be coupled with an RF chain to form an MR or the LP-WUR. The components of the UE 2300 may be implemented as integrated circuits (ICs), portions thereof, discrete electronic devices, or other modules, logic, hardware, software, firmware, or a combination thereof. The block diagram of FIG. 23 is intended to show a high-level view of some of the components of the UE 2300. However, some of the components shown may be omitted, additional components may be present, and different arrangements of the components shown may occur in other implementations.

The components of the UE 2300 may be coupled with various other components over one or more interconnects 2332, which may represent any type of interface, input/output, bus (local, system, or expansion), transmission line, trace, optical connection, etc. that allows various circuit components (on common or different chips or chipsets) to interact with one another.

The processors 2304 may include processor circuitry, such as baseband processor circuitry (BB) 2304A, central processor unit circuitry (CPU) 2304B, and graphics processor unit circuitry (GPU) 2304C. The processors 2304 may include any type of circuitry or processor circuitry that executes or otherwise operates computer-executable instructions, such as program code, software modules, or functional processes from memory/storage 2312 to cause the UE 2300 to perform operations as described herein.

In some embodiments, the baseband processor circuitry 2304A may access a communication protocol stack 2336 in the memory/storage 2312 to communicate over a 3GPP compatible network. In general, the baseband processor circuitry 2304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 2308.

The baseband processor circuitry 2304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 2304A may also access group information from memory/storage 2312 to determine search space groups in which a number of repetitions of a PDCCH may be transmitted.

The memory/storage 2312 may include any type of volatile or non-volatile memory that may be distributed throughout the UE 2300. In some embodiments, some of the memory/storage 2312 may be located on the processors 2304 themselves (for example, L1 and L2 cache), while other memory/storage 2312 is external to the processors 2304 but accessible thereto via a memory interface. The memory/storage 2312 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 2308 may include transceiver circuitry and a radio frequency front module (RFEM) that allows the UE 2300 to communicate with other devices over a radio access network. The RF interface circuitry 2308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 2350 and proceed to filter and amplify (with a low-noise amplifier) the signal. The signal may be provided to a receiver of the transceiver that down-converts the RF signal into a baseband signal that is provided to the baseband processor of the processors 2304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 2350.

In various embodiments, the RF interface circuitry 2308 may be configured to transmit/receive signals in a manner compatible with NR access technologies.

The antenna 2350 may include a number of antenna elements that each convert electrical signals into radio waves to travel through the air and to convert received radio waves into electrical signals. The antenna elements may be arranged into one or more antenna panels. The antenna 2350 may have antenna panels that are omnidirectional, directional, or a combination thereof to enable beamforming and multiple input, multiple output communications. The antenna 2350 may include microstrip antennas, printed antennas fabricated on the surface of one or more printed circuit boards, patch antennas, phased array antennas, etc. The antenna 2350 may have one or more panels designed for specific frequency bands including bands in FR1 or FR2.

The user interface circuitry 2316 includes various input/output (I/O) devices designed to enable user interaction with the UE 2300. The user interface 2316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 2300.

The sensors 2320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2322 may include software and hardware elements that operate to control particular devices that are embedded in the UE 2300, attached to the UE 2300, or otherwise communicatively coupled with the UE 2300. The driver circuitry 2322 may include individual drivers allowing other components to interact with or control various input/output (I/O) devices that may be present within, or connected to, the UE 2300. For example, driver circuitry 2322 may include a display driver to control and allow access to a display device, a touchscreen driver to control and allow access to a touchscreen interface, sensor drivers to obtain sensor readings of sensor circuitry 2320 and control and allow access to sensor circuitry 2320, drivers to obtain actuator positions of electro-mechanic components or control and allow access to the electro-mechanic components, a camera driver to control and allow access to an embedded image capture device, audio drivers to control and allow access to one or more audio devices.

The PMIC 2324 may manage power provided to various components of the UE 2300. In particular, with respect to the processors 2304, the PMIC 2324 may control power-source selection, voltage scaling, battery charging, or DC-to-DC conversion.

In some embodiments, the PMIC 2324 may control, or otherwise be part of, various power saving mechanisms of the UE 2300. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 2300 may power down for brief intervals of time and thus save power. If there is no data traffic activity for an extended period of time, then the UE 2300 may transition off to an RRC_Idle state, where it disconnects from the network and does not perform operations, such as channel quality feedback, handover, etc. The UE 2300 goes into a very low power state and it performs paging where again it periodically wakes up to listen to the network and then powers down again. The UE 2300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 2328 may power the UE 2300, although in some examples the UE 2300 may be mounted deployed in a fixed location and may have a power supply coupled to an electrical grid. The battery 2328 may be a lithium-ion battery, a metal-air battery, such as a zinc-air battery, an aluminum-air battery, a lithium-air battery, and the like. In some implementations, such as in vehicle-based applications, the battery 2328 may be a typical lead-acid automotive battery.

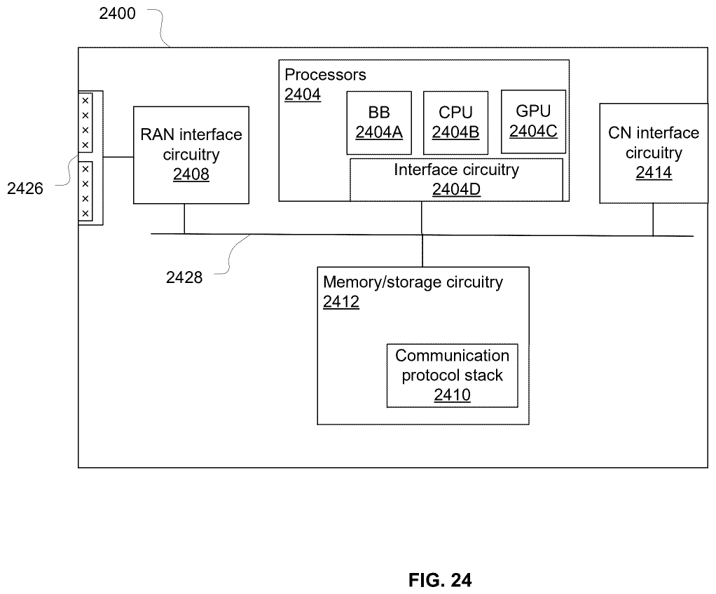

FIG. 24 illustrates a base station 2400, in accordance with some embodiments. The base station 2400 may be similar to and substantially interchangeable with the base station 108 of FIG. 1 and other base stations described herein above. Particularly, the base station 2400 can configure a UE with multiple CSI configurations, can decide which of these configurations is to be used based on a set of factors, and can indicate the decision to the UE.

The base station 2400 may include processors 2404, RAN interface circuitry 2408, core network (CN) interface circuitry 2412, and memory/storage circuitry 2416.

The components of the base station 2400 may be coupled with various other components over one or more interconnects 2428.

The processors 2404, RAN interface circuitry 2408, memory/storage circuitry 2416 (including communication protocol stack 2410), antenna 2450, and interconnects 2428 may be similar to like-named elements shown and described with respect to FIG. 23.

The CN interface circuitry 2412 may provide connectivity to a core network, for example, a Fifth Generation Core network (5GC) using a 5GC-compatible network interface protocol, such as carrier Ethernet protocols, or some other suitable protocol. Network connectivity may be provided to/from the base station 2400 via a fiber optic or wireless backhaul. The CN interface circuitry 2412 may include one or more dedicated processors or FPGAs to communicate using one or more of the aforementioned protocols. In some implementations, the CN interface circuitry 2412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method comprising: processing configuration information indicating a channel state information (CSI) Type I configuration and a CSI Type II configuration; determining a first rank indicator (RI) based on a first process that uses the CSI type I configuration; determining a second RI based on a second process that uses the CSI type II configuration and the first RI; and generating a CSI report that includes the second RI and that corresponds to the CSI type II configuration.

Example 2 includes a method comprising: processing configuration information received via the receiver and indicating a channel state information (CSI) Type I configuration and a CSI Type II configuration; processing an indication received via the receiver and requesting the CSI Type II configuration to be used for CSI reporting; determining, based on the indication, a first rank indicator (RI) based on a first process that uses the CSI type I configuration; determining a second RI based on a second process that uses the CSI Type II configuration and the first RI; and generating a CSI report that includes the second RI and that corresponds to the CSI type II configuration.

Example 3 includes a method comprising: sending, to a user equipment (UE), configuration information indicating a plurality of channel state information (CSI) configurations, the plurality of CSI configurations including a Type I configuration and a CSI Type II configuration; sending, to the UE, an indication to use the CSI type II configuration for CSI reporting; and receiving, from the UE based on the indication, a CSI report, wherein the CSI report is generated based on using a first rank indicator (RI) corresponding to the CSI Type I configuration in a process that uses the CSI type II configuration.

Example 4 includes the method of any example 1-3, wherein the second process or the process uses a constraint on a set of candidate RIs in a CSI Type II computation, wherein the constraint is based on the first RI.

Example 5 includes the method of example 4, wherein the constraint limits the set of candidate RIs to the first RI.

Example 6 includes the method of example 4, wherein the constraint limits the set of candidate RIs to a range of RIs, wherein the range is based on the first RI.

Example 7 includes the method of example 6, wherein the first RI has a first value, and wherein the other RI has another value corresponding to an increment of the first value by one.

Example 8 includes the method of example 4, wherein the constraint limits the set of candidate RIs to the first RI and to another RI adjacent to the first RI.

Example 9 includes the method of any example 1-8, further comprising: processing an indication to use the CSI type II configuration instead of the CSI type I configuration for the CSI report, wherein the first RI is generated after the indication is processed in support of reducing a complexity of the second RI being determined.

Example 10 includes the method of any example 1-9, wherein the first RI is determined based on a first search of a first codebook associated with the CSI type I configuration.

Example 11 includes the method of example 10, wherein the second RI is determined based on a second search of a second codebook associated with the CSI type II configuration, wherein the second search is based on the first RI.

Example 12 includes the method of any example 1-11, wherein the first RI corresponds to a maximum throughput capacity based on a CSI Type I codebook, wherein the second process uses a constraint on a set of candidate RIs in a CSI Type II computation, wherein the constraint excludes RIs ranked lower than the first RI from the set.

Example 13 includes the method of any example 1-12, further comprising: determining a third RI based on the second process or the process that uses the CSI type II configuration; and determining a fourth RI based on the first process or a first process that uses the CSI type I configuration and the third RI.

Example 14 includes the method of any example 1-3, wherein the configuration information further indicates a periodic CSI reference signal (CSI-RS) configuration, and wherein each one of the CSI Type I configuration and the CSI Type II configuration is for aperiodic CSI reporting.

Example 15 includes the method of example 14, wherein the indication corresponds to first CSI reporting using the CSI Type II configuration being requested based on a network condition.

Example 16 includes the method of example 15, wherein second CSI reporting using the CSI type I configuration is requested based on a change to the network condition.

Example 17 includes the method of example 14, wherein the indication corresponds to first CSI reporting using the CSI Type II configuration being requested based on one or more of: an estimated throughput capacity associated with at least one of the CSI Type I configuration or the CSI Type II configuration, a Doppler metric of the UE, a measurement of a reference signal, a position of the UE relative to a base station, or a limitation on a resource of the UE.

Example 18 includes the method of example 17, wherein the configuration information is received via radio resource control (RRC) signal and further indicates a periodic CSI reference signal (CSI-RS) configuration, and wherein each one of the CSI Type I configuration and the CSI Type II configuration is for aperiodic CSI reporting.

Example 19 includes the method of any example 1-18, wherein the indication is received in downlink control information (DCI) and corresponds to a selection of the CSI Type II configuration based on a network condition or a user equipment (UE)-related condition.

Example 20 includes the method of any example 1-20, wherein the CSI Type II configuration includes a CSI enhanced Type (eType) II configuration.

Example 21 includes a user equipment (UE) or an apparatus comprising: one or more processors; and one or more memory storing instructions that, upon execution by the one or more processors, configure the UE or the apparatus to perform a method described in or related to any of the preceding examples.

Example 22 includes one or more computer-readable media storing instructions that, when executed on a user equipment (UE) or an apparatus, cause the UE or the apparatus to perform operations comprising one or more elements of a method described in or related to any of the preceding examples.

Example 23 includes an apparatus comprising means to perform one or more elements of a method described in or related to any of the preceding examples.

Example 24 includes one or more non-transitory computer-readable media comprising instructions to cause an apparatus, upon execution of the instructions by one or more processors of the apparatus, to perform one or more elements of a method described in or related to any of the preceding examples.

Example 25 includes an apparatus comprising logic, modules, or processing circuitry configured to perform one or more elements of a method described in or related to any of the preceding examples.

Example 26 includes an apparatus, a network, a base station, or a system comprising: one or more processors and one or more computer-readable media comprising instructions that, when executed by the one or more processors, cause the one or more processors to perform one or more elements of a method described in or related to any of the preceding examples.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
processing configuration information indicating a channel state information (CSI) Type I configuration and a CSI Type II configuration;
determining a first rank indicator (RI) based on a first process that uses the CSI type I configuration;
determining a second RI based on a second process that uses the CSI type II configuration and the first RI; and
generating a CSI report that includes the second RI and that corresponds to the CSI type II configuration.

2. The method of claim 1, wherein the second process uses a constraint on a set of candidate RIs in a CSI Type II computation, wherein the constraint is based on the first RI.

3. The method of claim 2, wherein the constraint limits the set of candidate RIs to the first RI.

4. The method of claim 2, wherein the constraint limits the set of candidate RIs to a range of RIs, wherein the range is based on the first RI.

5. The method of claim 4, wherein the first RI has a first value, and wherein the other RI has another value corresponding to an increment of the first value by one.

6. The method of claim 2, wherein the constraint limits the set of candidate RIs to the first RI and to another RI adjacent to the first RI.

7. The method of claim 1, further comprising:
processing an indication to use the CSI type II configuration instead of the CSI type I configuration for the CSI report, wherein the first RI is generated after the indication is processed in support of reducing a complexity of the second RI being determined.

8. The method of claim 1, wherein the first RI is determined based on a first search of a first codebook associated with the CSI type I configuration.

9. The method of claim 8, wherein the second RI is determined based on a second search of a second codebook associated with the CSI type II configuration, wherein the second search is based on the first RI.

10. The method of claim 1, wherein the first RI corresponds to a maximum throughput capacity based on a CSI Type I codebook, wherein the second process uses a constraint on a set of candidate RIs in a CSI Type II computation, wherein the constraint excludes RIs ranked lower than the first RI from the set.

11. The method of claim 1, further comprising:
determining a third RI based on the second process that uses the CSI type II configuration; and
determining a fourth RI based on the first process that uses the CSI type I configuration and the third RI.

12. A base station comprising:
one or more processors; and
one or more memories storing instructions that, upon execution by the one or more processors, configure the base station to:
send, to a user equipment (UE), configuration information indicating a plurality of channel state information (CSI) configurations, the plurality of CSI configurations including a Type I configuration and a CSI Type II configuration;
send, to the UE, an indication to use the CSI type II configuration for CSI reporting; and
receive, from the UE based on the indication, a CSI report, wherein the CSI report is generated based on using a first rank indicator (RI) corresponding to the CSI Type I configuration in a process that uses the CSI type II configuration.

13. The base station of claim 12, wherein the configuration information further indicates a periodic CSI reference signal (CSI-RS) configuration, and wherein each one of the CSI Type I configuration and the CSI Type II configuration is for aperiodic CSI reporting.

14. The base station of claim 13, wherein the indication corresponds to first CSI reporting using the CSI Type II configuration being requested based on a network condition.

15. The base station of claim 14, wherein second CSI reporting using the CSI type I configuration is requested based on a change to the network condition.

16. The base station of claim 13, wherein the indication corresponds to first CSI reporting using the CSI Type II configuration being requested based on one or more of: an estimated throughput capacity associated with at least one of the CSI Type I configuration or the CSI Type II configuration, a Doppler metric of the UE, a measurement of a reference signal, a position of the UE relative to a base station, or a limitation on a resource of the UE.

17. An apparatus comprising:
a receiver;
a transmitter; and
processing circuitry communicatively coupled with the receiver and the transmitter and configured to:
process configuration information received via the receiver and indicating a channel state information (CSI) Type I configuration and a CSI Type II configuration;
process an indication received via the receiver and requesting the CSI Type II configuration to be used for CSI reporting;
determine, based on the indication, a first rank indicator (RI) based on a first process that uses the CSI type I configuration;
determine a second RI based on a second process that uses the CSI Type II configuration and the first RI; and
generate a CSI report that includes the second RI and that corresponds to the CSI type II configuration.

18. The apparatus of claim 17, wherein the configuration information is received via radio resource control (RRC) signal and further indicates a periodic CSI reference signal (CSI-RS) configuration, and wherein each one of the CSI Type I configuration and the CSI Type II configuration is for aperiodic CSI reporting.

19. The apparatus of claim 18, wherein the indication is received in downlink control information (DCI) and corresponds to a selection of the CSI Type II configuration based on a network condition or a user equipment (UE)-related condition.

20. The apparatus of claim 17, wherein the CSI Type II configuration includes a CSI enhanced Type (eType) II configuration.
